(19) United States
(12) Patent Application Publication
(10) Pub. No.: US 2025/0187201 A1
(43) Pub. Date: Jun. 12, 2025

(54) MOBILE ROBOTIC PROCESSING STATION, PROCESSING SYSTEM, AND METHOD THEREFOR

(71) Applicant: HighRes Biosolutions, Inc., Beverly, MA (US)

(72) Inventors: Tyler Dendas, Beverly, MA (US); Robert Connors, Wakefield, MA (US); Quinlan McDonnell, Salem, MA (US); Donald McIntyre, Boston, MA (US); Blaine Stevenson, Rockport, MA (US)

(21) Appl. No.: 18/970,333

(22) Filed: Dec. 5, 2024

Related U.S. Application Data
(60) Provisional application No. 63/709,266, filed on Oct. 18, 2024.
(60) Provisional application No. 63/607,405, filed on Dec. 7, 2023.

(51) Int. Cl. B25J 9/16

(52) U.S. Cl. CPC B25J 9/1697; B25J 9/1664

(57) ABSTRACT

A collaborative robot including: a movable base to movably position the collaborative robot at different variable work locations; an articulated robot actuator movable relative to the base to effect with a robot end effector a predetermined function corresponding to at least one workstation at the at least one work location, the at least one workstation having an undeterministic variable pose with respect to the at least one work location; a vision system connected to the articulated robot actuator to image a vision target connected to and corresponding uniquely to each of the at least one workstation; and a controller to determine from the image data the workstation pose relative to the movable base and automatically teach the articulated robot actuator the workstation pose so as to effect a predetermined deterministic interface, associated with a predetermined workstation function characteristic, between the workstation and robot end effector.

### CROSS REFERENCE TO RELATED APPLICATIONS

This application claims the benefit of provisional patent Application No. 63/709,266, filed on Oct. 18, 2024, and provisional patent Application No. 63/607,405, filed on Dec. 7, 2023 the disclosures of which are incorporated by reference herein in their entireties.

### BACKGROUND

### 1. Field

The exemplary embodiments generally relate to life sciences equipment, and more particularly, to automated handling and processing of life sciences equipment.

### 2. Brief Description of Related Developments

Scientific experimentation in the life sciences industry is generally performed in one or more work cells where processing equipment (e.g., dispensers, incubators, readers, spinners, defrosters, freezers, decappers/cappers, hotels, etc.) are disposed adjacent one another to in groups to form a respective work cell. One type of automation tool employed in the work cells is a mobile cart that is used to carry items from one location to another within the laboratory facility. These mobile carts generally interact with other automated processing equipment and may be used to transfer laboratory samples and/or engage a processing station so that the samples carried by the mobile cart may be processed by the processing station.

Some of the mobile carts include robots thereon, where the robot may be used to mix/stir, transfer, or complete a process on the samples. These robots, when interacting with other processing equipment must be calibrated with respect to the other processing equipment so that items may be transferred (e.g., picked/placed) between the different processing equipment of the work cell. The calibration and configuration of the robots for interface with the different processing equipment of the respective work cell is generally tedious and time consuming.

In a general laboratory environment, there are “portable robotic manipulation systems” that are configured to perform different tasks in different environments. However, in these portable robotic manipulation systems the locations at which these tasks are performed are static (i.e., have a fixed configuration/arrangement) such that each location has a static task (i.e., each location has a predetermined respective task that is always the same for that location and does not change). Here, the robot of the portable robotic manipulation system may be reconfigurable as to the tasks it may perform however; the configuration of the robot is related to the static task at a respective static location.

Accordingly, the present disclosure addresses a number of those issues.

### BRIEF DESCRIPTION OF THE DRAWINGS

The foregoing aspects and other features of the disclosed embodiment are explained in the following description, taken in connection with the accompanying drawings, wherein:

FIG. 1 is an perspective illustration of an exemplary collaborative process facility in accordance with the present disclosure;

FIGS. 2A-2D are perspective illustration of an exemplary collaborative robots, in accordance with the present disclosure, that may be employed in the collaborative process facility of FIG. 1;

FIG. 3 is a partial perspective illustration of a portion of an exemplary collaborative robot, in accordance with the present disclosure, that may be employed in the collaborative process facility of FIG. 1;

FIG. 4 is a side view illustration of an exemplary collaborative robot, in accordance with the present disclosure, that may be employed in the collaborative process facility of FIG. 1;

FIGS. 5-8 are plan view illustrations of exemplary collaborative robots, in accordance with the present disclosure, that may be employed in the collaborative process facility of FIG. 1 and having various configurations;

FIGS. 9A-9I are plan view illustrations of exemplary work locations of the collaborative process facility of FIG. 1 in accordance with the present disclosure;

FIG. 10 is a flow diagram of an exemplary method in accordance with the present disclosure;

FIG. 11 is a flow diagram of an exemplary method in accordance with the present disclosure;

FIG. 12 is a flow diagram of a method in accordance with the present disclosure;

FIGS. 13A and 13B are exemplary schematic top view illustrations of an article holding station in accordance with the present disclosure;

FIGS. 14A-14E are schematic illustrations of a compliance mode of the collaborative robots described herein and a refinement of an article place position in accordance with the present disclosure;

FIG. 15 is a flow diagram of an exemplary method in accordance with the present disclosure;

FIG. 16 is a schematic illustration of end effector pose before and after a refinement of an article place position in accordance with the present disclosure;

FIGS. 17A-17C illustrate an exemplary placement of an article at an article holding location in accordance with the present disclosure; and

FIGS. 18A-18C illustrate an exemplary placement of an article at an article holding location in accordance with the present disclosure.

### DETAILED DESCRIPTION

The following detailed description is meant to assist the understanding of one skilled in the art, and is not intended in any way to unduly limit claims connected or related to the present disclosure.

The following detailed description references various figures, where like reference numbers refer to like components and features across various figures, whether specific figures are referenced, or not.

The word “each” as used herein refers to a single object (i.e., the object) in the case of a single object or each object in the case of multiple objects. The words “a,” “an,” and “the” as used herein are inclusive of “at least one” and “one or more” so as not to limit the object being referred to as being in its “singular” form.

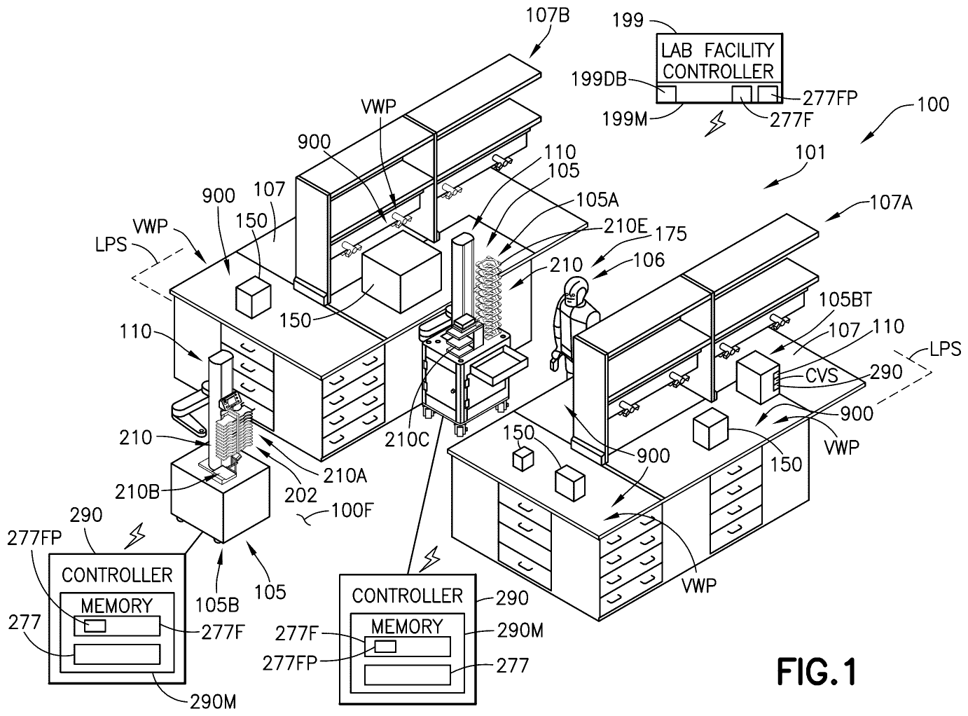

FIG. 1 illustrates an exemplary laboratory facility or collaborative process facility 100 in accordance with the present disclosure. Although the present disclosure will be described with reference to the drawings, it should be understood that the present disclosure can be embodied in many forms. In addition, any suitable size, shape or type of elements or materials could be used.

The collaborative process facility 100 is illustrated as a collaborative workspace that provides a hybrid approach of running experiments or laboratory processes, by extending the workday for manually driven experiments by having mobile robotic operators assisting humans. The mobile robotic operators described herein are configured to run the steps of the process that make sense for automation, and humans are instructed or prompted as applicable (i.e., serially, or simultaneously, or in parallel with automation) to run elements of the process with data sent to mobile devices that are accessible to the humans.

The mobile robotic operators are described herein in the form one or more collaborative robots 105. One or more of the collaborative robots 105 may be configured as a manually traversing collaborative robot 105A where a human 106 manually manipulates (e.g., pushes, pulls, rotates, etc.) the collaborative robot 105A so as to place the collaborative robot 105A in a non-deterministic position within a work cell or other operating area (also referred to herein as a work location 900), such as adjacent one or more workbenches 107 at which the human 106 is stationed for processing life sciences equipment, lab work, biological sample processing, and/or experimentation. Another of the one or more collaborative robot 105 may be configured as an automated vehicle or autonomous traverse collaborative robot 105B that autonomously traverses the collaborative process facility floor 100F for autonomous positioning of the collaborative robot 105B at a non-deterministic position at the work location 900. It is noted that the term “non-deterministic position” as used herein means a position that is variable and not physically constrained in six degrees of freedom. The collaborative robot 105B may be substantially similar to that described in U.S. Pat. No. 10,955,430 issued on Mar. 23, 2021 and U.S. Pat. No. 11,123,870 issued on Sep. 21, 2021 (the disclosures of which are incorporated herein by reference in their entirety) except as noted herein. The collaborative robots 105 are configured to be easily moved and quickly set up (e.g., as described herein) across the collaborative process facility 100 to automate, for example, benchtop operations that were traditionally performed manually by a human 106 operator.

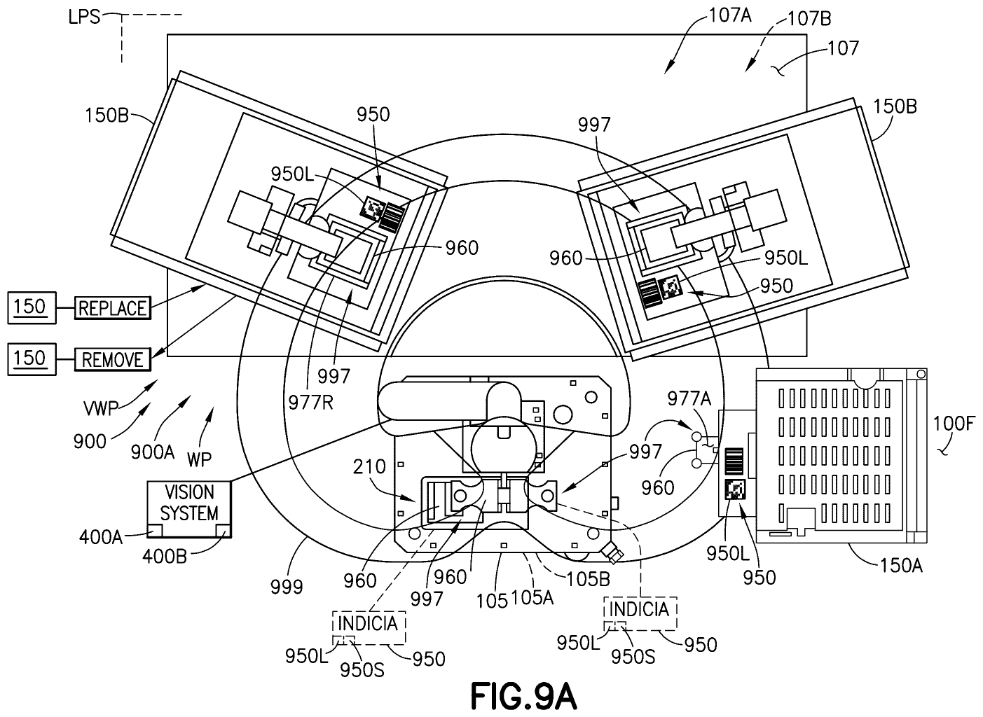

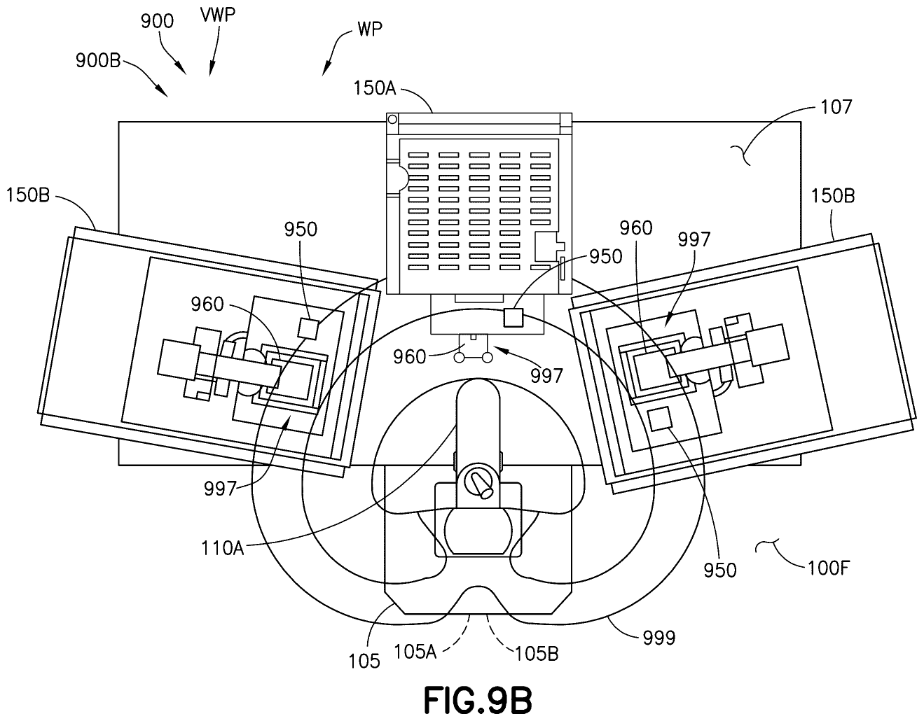

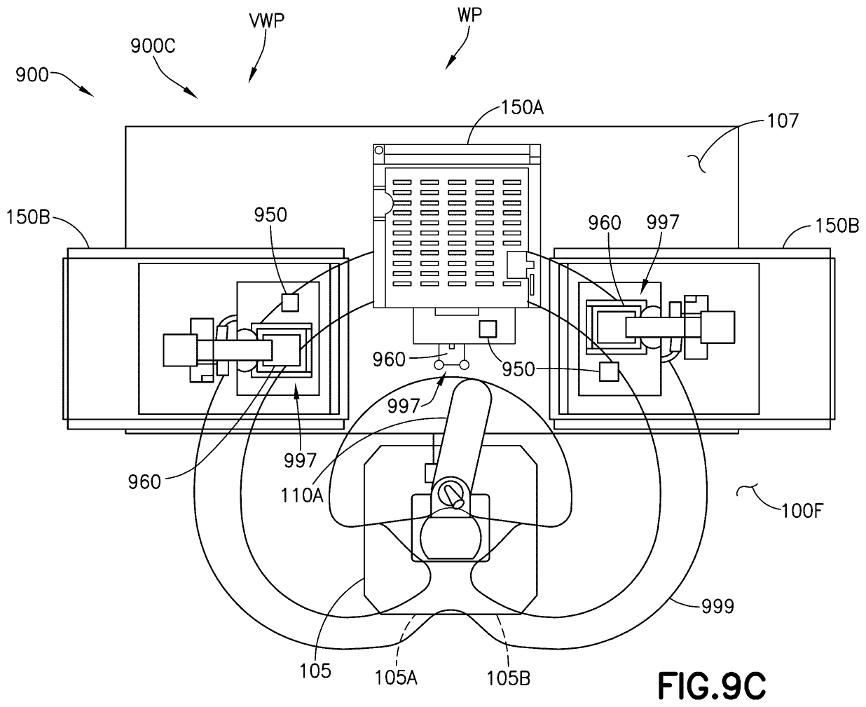

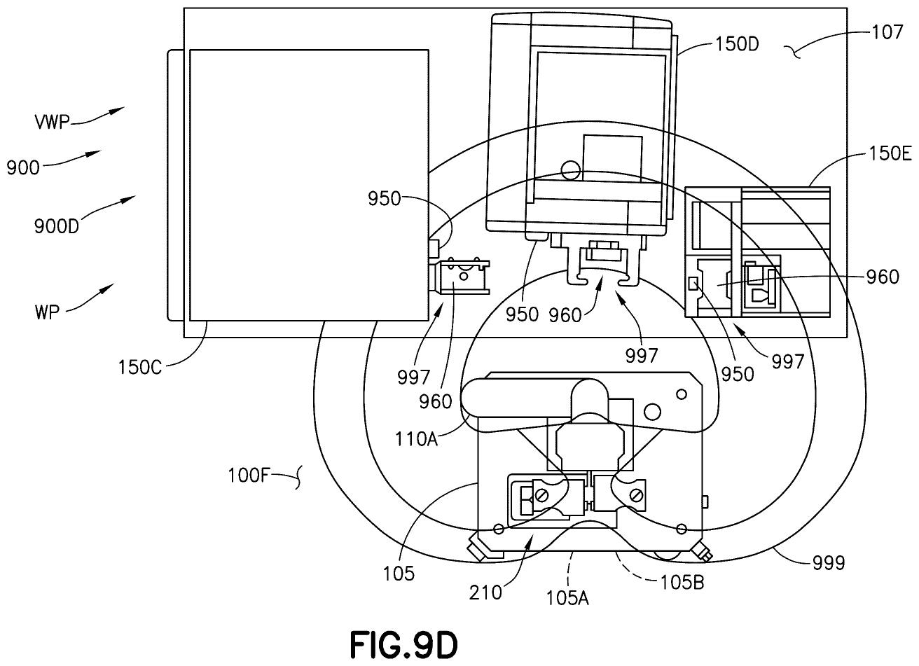

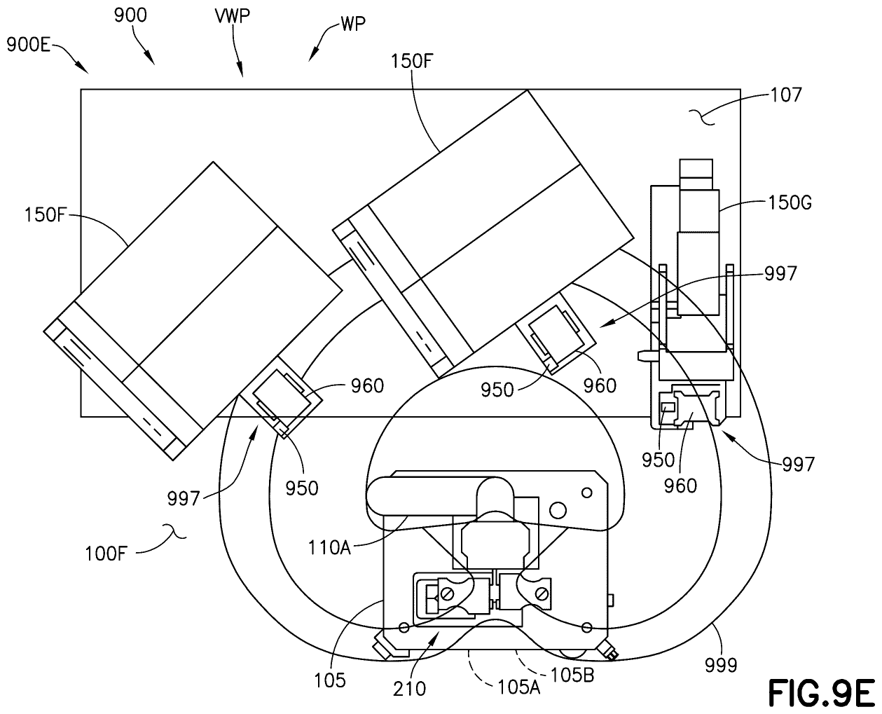

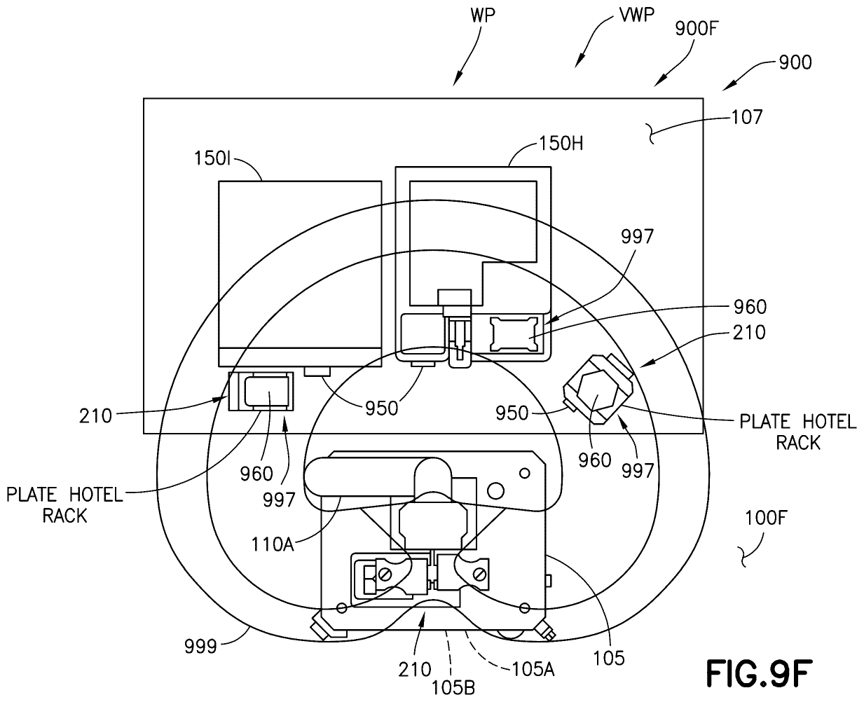

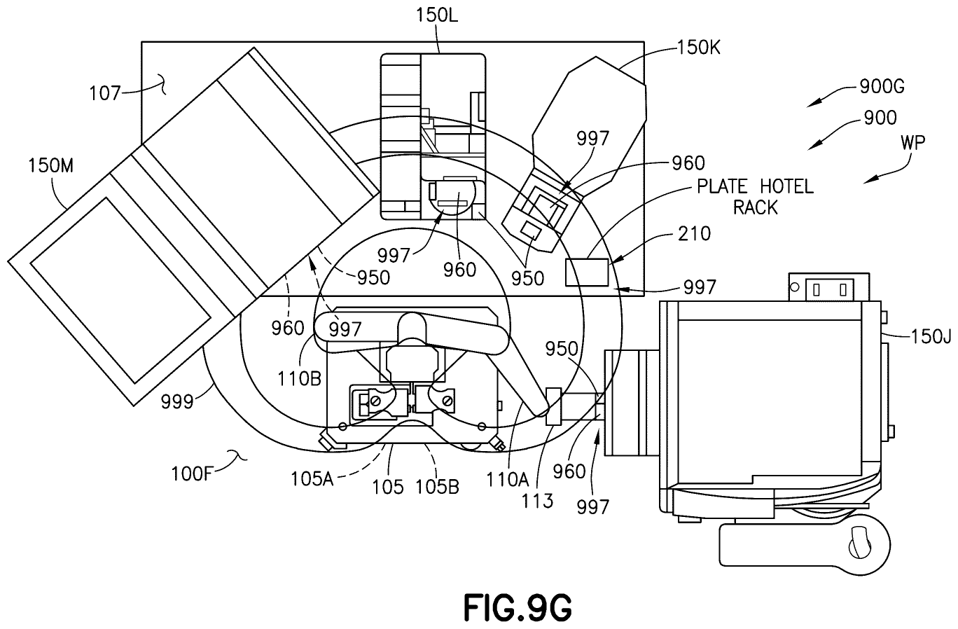

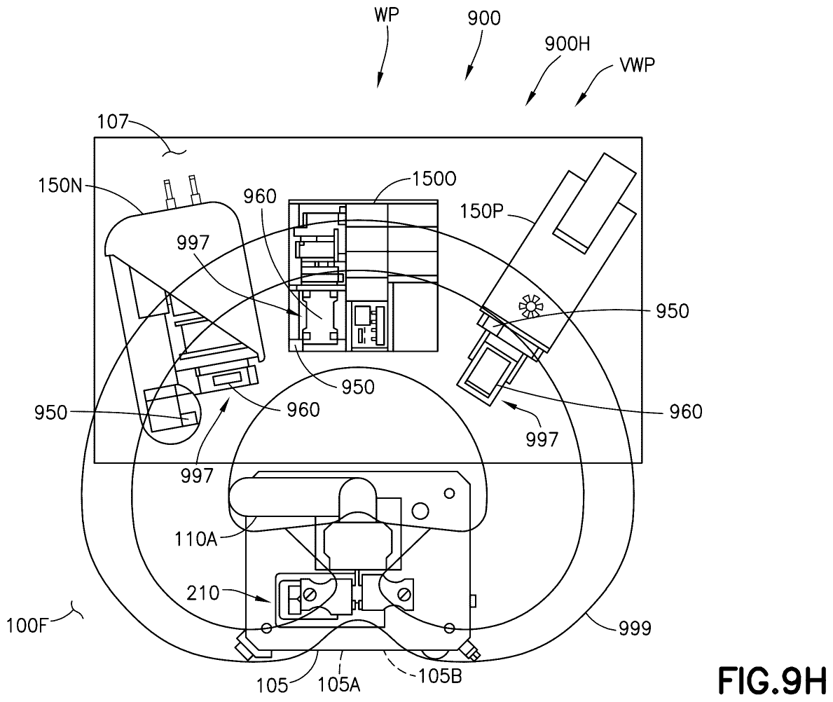

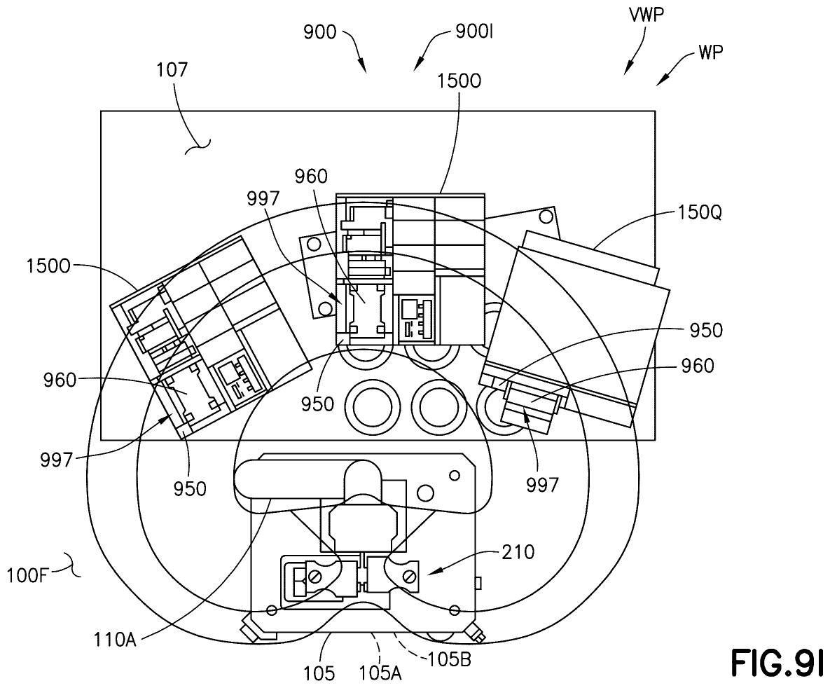

With the collaborative robot 105 disposed at the non-deterministic position at the work location 900, the collaborative robot 105 is immobilized (e.g., by locking the wheels in any suitable manner, such as for example, manually or automatically) so as to fix the collaborative robot 105 relative the floor 100F (and within or at the work location 900) in the non-deterministic location substantially without special tools or special equipment (as described herein). The collaborative robot 105 may be configured as a communication hub between an articulated robot actuator 110 mounted on the collaborative robot 105, existing workstations (also referred to herein as benchtop devices or process tools) 150, and any suitable scheduling software to provide users of the collaborative process facility 100 flexibility when automating experiments or laboratory processes. The workstations 150 (see also workstations 150A-150Q in FIGS. 9A-9I, generally referred to as workstations 150) may include, but are not limited to, one or more of microplate dispensers (e.g., having a microplate dispensing function), environmental control modules (e.g., functioning as incubators, defrosters, freezers, refrigerators, clean environments, hoods, etc.), readers (e.g., having an optical code reading function), spinners/centrifuges (e.g., having a centrifugation of samples function), decappers/cappers (e.g., having a respective container decapping/capping function), plate hotel racks (e.g., having a storage function), random access sample storage carousels (e.g., having a storage and retrieval function), high density labware stacker carousels (e.g., having a storage and retrieval function), sequential sample storage carousels (e.g., having a storage and retrieval function), weight scales (e.g., having a weighing function), de-lidders (e.g., having a container delidding function), lidders (e.g., having a container lidding function), electronic pipettor (e.g., having a liquid dispensing function), media preparation modules (e.g., functioning to sterilize and dispense sample media), and any other suitable processing tool (having a corresponding predetermined function characteristic) that is disposed on the one or more workbenches 107 and/or on the collaborative robot 105. The workstations 150 are interchangeable with each other on a workbench 107 (e.g., so as to configure and re-configure the work location 900) depending on the processes to be performed at the work location 900.

The scheduling software may drive operation of the collaborative robots 105 and/or existing devices (such as one or more of the workstations 150, 150A-150Q, 210, 210A-210G) to run specific biological applications (with respect to, e.g., the experiments or laboratory processes, such biological applications including, but not being limited to, freezer operation, high throughput screening operator, general lab worker, cell culture operator, and clinical sample accessioning) and instructs humans 106 to run specific parts of the same biological applications. The articulated robot actuators 110 on the collaborative robots 105 described herein are configured to run the steps of the biological operations that make sense for automation, and the humans 106 are instructed or prompted as applicable (i.e., serially, simultaneously, or in parallel with automation). The collaborative robots 105 described herein may also provide for one or more of on-board storage of labware and/or samples, standardized device integration, and a list of pre-configured compatible devices that will enable the user of the collaborative process facility 100 to tailor one or more processing systems 101 of the collaborative process facility 100 without specially configured software or hardware.

As described herein, the collaborative robots 105 and the workstations 150 are non-deterministically positioned relative to one another to form a work location 900 (see, e.g., FIG. 9A-9I) where a position of the work location 900 can be moved within the collaborative process facility 100 (i.e., the work location is not at a fixed location in the collaborative process facility 100 such that the processing station may be moved to different positions within the collaborative process facility 100), and the tasks performed in the processing station can be changed (e.g., through the interchangeability of the workstations 150) as desired to effect desired processing of labware and/or samples held in the labware. In accordance with the present disclosure, the collaborative robots 105 and the articulated robot actuator 110 thereof is not unique to a given processing station. For example, the collaborative robots 105 may be differently configured from one collaborative robot to another of the collaborative robots but yet these differently configured collaborative robots may perform the same tasks, although the collaborative robots 105 may be differently configured for performing different tasks. Each of the collaborative robots 105 may be employed with any desired combination of workstations 150 for effecting any desired process on labware or samples held thereby within the collaborative process facility 100.

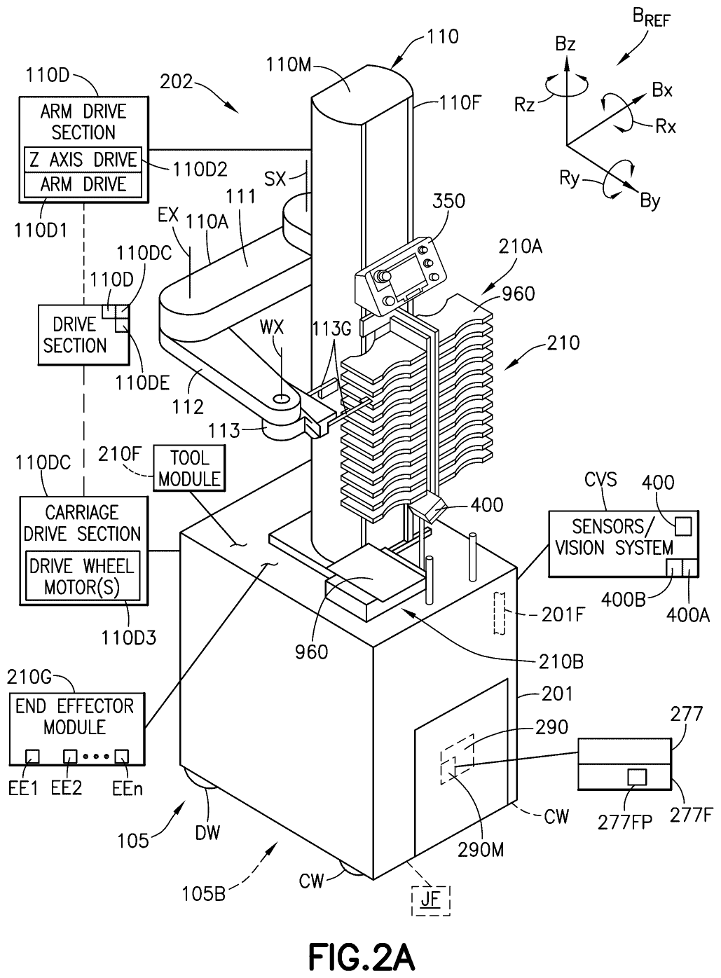

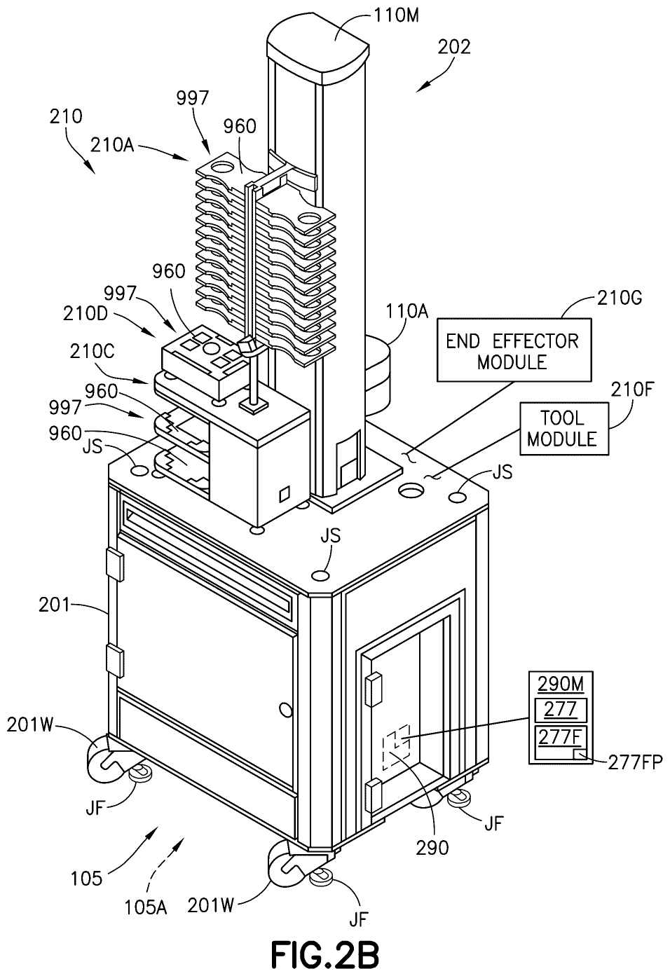

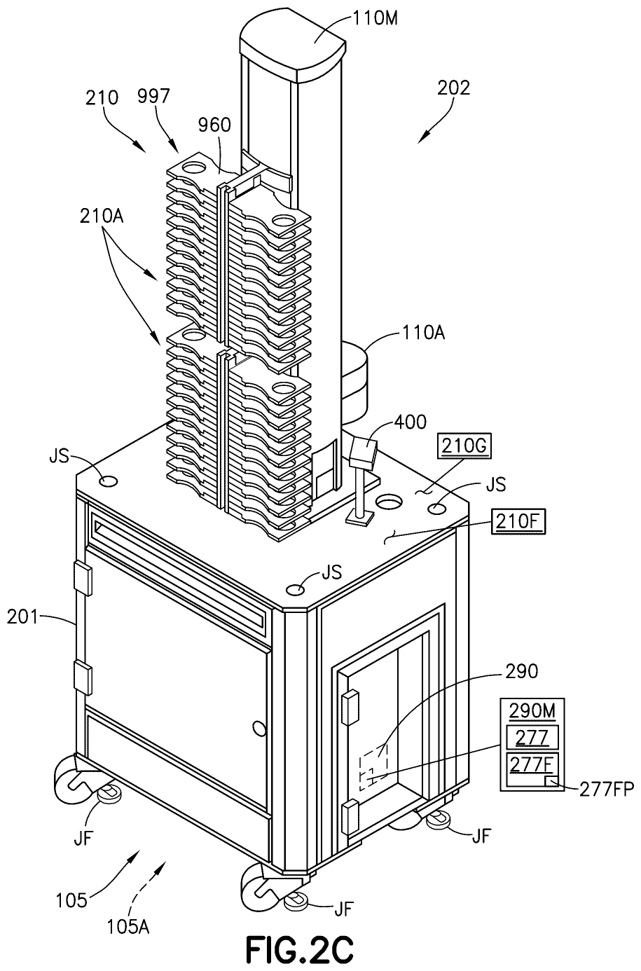

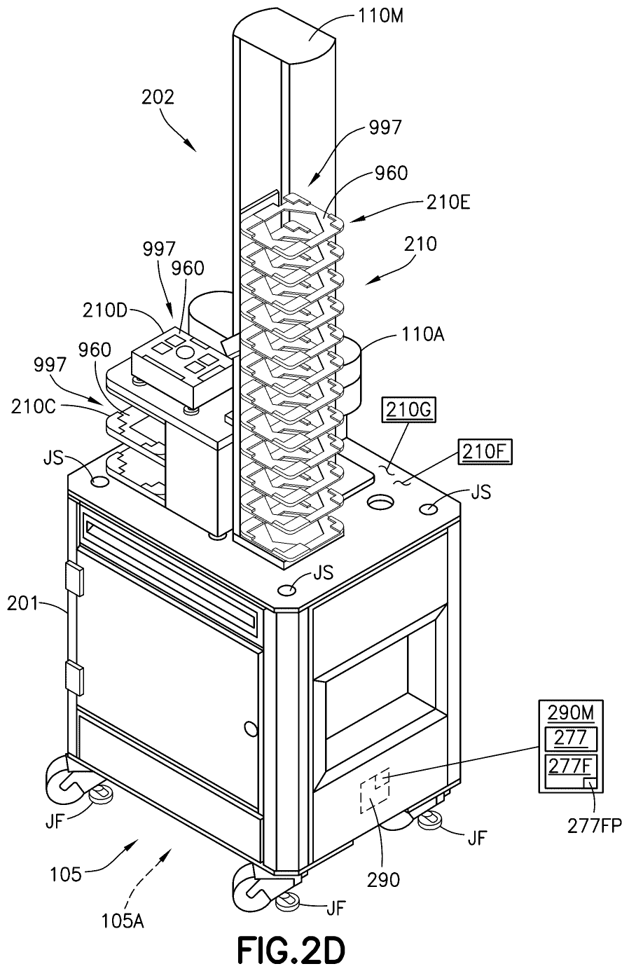

As described herein, the collaborative robots 105 may include a processing section 202 that includes the articulated robot actuator 110 and/or may include one or more processing modules/tools 210A-210G (also referred to as workstations, and referred to generally as workstations 210). The workstations 210 include, but are not limited to, for example, one or more of labware storage, plate lidding devices, plate de-lidding devices, plate orienting devices, lid disposal devices, end effectors, hand held tools, one or more of the workstations 150, etc., The collaborative robots 105 may service individual processing areas 107A, 107B (each processing area having one or more work location 900), where the processing areas 107A, 107B have one or more of automatic item/article ART (e.g., tools, samples, trays, etc.) input/output and manual processes which are carried out/effected, monitored, and/or controlled (e.g., through a user interface) by a human 106. The articulated robot actuators 110 on the collaborative robots 105 may provide or otherwise generate, at each process area 107A, 107B repeatable or “near identical” process steps (e.g., the process steps are performed with automatic machine repetition controlled by controller 290 of the collaborative robot 105, see FIGS. 2A-2D).

Still referring to FIG. 1 and also to FIGS. 9A-9I, the processing area 107A, 107B may have a linear arrangement and include one or more workstations (e.g., processing modules or tools) 150A-150Q, generally referred to herein as workstations 150. It is noted that FIG. 1 illustrates human processing area 107A, 107B that may or may not include automated processes (e.g., an automated work cell or processing station at a work location 900) however, the present disclosure is not limited to the human processing area 107A, 107B. For example, the at least one collaborative robot 105 may be configured to effect one or more predetermined laboratory processing function at a workstation 150A-150Q of work location 900 (exemplary work locations 900, 900A-900I are illustrated in FIGS. 1 and 9A-9I and generally referred to as work locations 900). The automated configurable work locations 900 may be arranged, at least partially on a workbench 107 of the respective processing area 107A, 107B so as to form an automated or semi-automated location 900 (e.g., having a clustered arrangement or a linear arrangement) that may or may not employ human 106 intervention in the processing of items; however, the automated configurable work locations 900 may be substantially similar to those clustered configurations described U.S. Pat. No. 8,734,720 issued on May 27, 2014, and/or the automated configurable work locations 900 may have a linear configuration similar to those described in U.S. Pat. No. 11,045,811 issued on Jun. 29, 2021 the disclosure of which are incorporated herein by reference in their entireties.

Referring to FIGS. 2A-2D, each of the one or more collaborative robot 105 includes a carriage or base 201, an articulated robot actuator 110, a sensor/vision system CVS, and a controller 290. The base 201 may be a movable base configured (such as described herein) so as to movably position the collaborative robot 105 at different variable work locations 900 (which work location, after the workstations are placed, is a static/stationary location) in the collaborative process facility 100.

As described herein, at least one of the work locations 900 has different variable work location characteristics. For example, the different variable work location characteristics may include, but are not limited to, those characteristics described herein such as a number of workstations 150, a spatial arrangement of workstations 150, types of workstation(s) 150, types of robot-human interactions, etc. As described herein, the base 201 (positioned manually or automatically at the work location 900) has an undeterministic pose (e.g., location and orientation) at each of the different work locations 900.

As also described herein, the articulated robot actuator 110 is based on (i.e., mounted on/to or otherwise supported on) the base 201 and has a robot end effector (also referred to herein as an end effector) 113. It should be understood that while the articulated robot actuator 110 is described as being based on the base 201, the articulated robot actuator 110 may be included in a benchtop collaborative robot 105BT (see FIG. 1) that is based on (i.e., mounted on/to or otherwise supported on) the workbench 107. The benchtop mounted articulated robot actuator 110BT may be substantially similar to articulated robot actuator 110 (inclusive of the sensor/vision system CVS, and controller 290) and have the same functionality as the articulated robot actuator 110 such that the benchtop mounted articulated robot actuator 110BT may be non-deterministically placed on the workbench 107 and interfaced with one or more workstations 150, 210 in the same manner as the articulated robot actuator 110.

The articulated robot actuator 110 has a motion, driven by a drive section 110D, with at least one degree of freedom relative to the base 201 to effect with the end effector 113 a predetermined function (such as those described herein) corresponding to at least one workstation 150, 150, 150A-150Q, 210A-210G, from more than one different interchangeable workstation 150, 150A-150Q, 210A-210G, at the at least one work location 900. The at least one workstation 150, 150, 150A-150Q, 210A-210G has an undeterministic variable pose with respect to the at least one work location 900 as described herein (see, e.g., FIGS. 1 and 9A-9I). The workstation pose WP is an undeterministic variable pose VWP of at least one work station 150, 150A-150Q, 210A-210G at the at least one of the variable work location 900.

The robot end effector 113, of the articulated robot actuator 110, has a motion, driven by the drive section 110D, with at least one degree of freedom relative to the base 201 to effect with the robot end effector 113 a predetermined function (such as those described herein) corresponding to at least one workstation 150, 150, 150A-150Q, 210A-210G at one of the work locations. The at least one workstation 150, 150, 150A-150Q, 210A-210G has a workstation pose (such as the undeterministic variable pose) with respect to the at least one work location.

The sensor/vision system CVS is connected to the articulated robot actuator 110 and disposed to image a vision target 950 (see, e.g., FIG. 9A) connected to and corresponding uniquely to each of the at least one workstation 150, 150A-150Q, 210A-210G so as to inform the workstation pose (e.g., location and orientation, with respect to the base 201/reference frame of the articulated robot actuator 110) and identify a predetermined function characteristic (such as those described herein) of the at least one workstation 150, 150A-150Q, 210A-210G.

The controller 290 may be operably connected to (e.g., at least) the articulated robot actuator 110 and is communicably connected to the vision system CVS to register image data from the vision system CVS of the vision target 950 (e.g., in the manner described herein). The controller 290 is configured (e.g., with any suitable non-transitory computer program code including, but not limited to, neural networks) so as to determine from the image data the workstation pose (e.g., location and orientation) relative to the base 201 (and/or reference frame of the articulated robot actuator 110) and automatically teach the articulated robot actuator 110 the workstation pose so as to effect a predetermined deterministic interface 997, associated with the predetermined function characteristic, between the workstation 150, 150A-150Q, 210A-210G and the robot end effector 113. The controller 290 may be operably connected to (e.g., at least) the articulated robot actuator 110 and is communicably connected to the vision system CVS register image data from the vision system CVS of the vision target 950 (e.g., in the manner described herein). The controller 290 may be configured (e.g., with any suitable non-transitory computer program code including, but not limited to, neural networks) so as to determine from the image data the workstation pose relative to the base 201 (reference frame of the articulated robot actuator 110) and automatically teach the articulated robot actuator 110 an interface location (e.g., labware load interface or article holding location 960) based on the workstation pose and the predetermined function characteristic identified by the image data so as to effect a predetermined deterministic interface 997 (see, e.g., FIG. 9A) at the interface location (e.g., labware load interface or article holding location 960) between the at least one workstation 150, 150A-150Q, 210, 210A-210G and robot end effector 113. It is noted that with the articulated robot actuator 110 at the taught interface location, the articulated robot actuator 110 and end effector 113 thereof, have respective positions and poses (where the pose includes position and orientation), which may be referred to as taught positions and taught poses at the predetermined deterministic interface 997.

The predetermined deterministic interface 997 (see, e.g., FIG. 9A) may be a receptacle 977R for receiving an article ART or an area 977A having known boundaries in which the article ART may be “grossly” placed by the articulated robot actuator 110. As used herein “gross” placement is a placement that provides full insertion of the article ART within the receptacle 977R or area 977A, although the article ART may not be centered within the receptacle 977R or area 977A. The workstation 150, 150A-150Q, 210, 210A-210G may be configured (e.g., with any suitable automation such as conveyors, grippers, turn-tables, etc.) to automatically position the article ART received in the area 977A to move the article from the “grossly” placed position to a “refined” position suitable for processing of the article ART. The articulated robot actuator 110 may include a compliance mode configured to refine the placement position of the article ART at the predetermined deterministic interface 997 so that the article ART is placed with a refined placement suitable for processing of the article ART, where the refined placement may be substantially at a center of the predetermined deterministic interface 997. As may be realized, each workstation 150, 150A-150Q, 210, 210A-210G equipped with the area 977A of placement includes a manufacturer specification defining the area 977A and the placement tolerances for the area 977A that enable placement accuracy of the articulated robot actuator 110 to be relaxed compared to placement accuracy for a receptacle 977R (the placement tolerances of which are also defined in the workstation manufacturer specifications). The placement tolerance for each workstation 150, 150A-150Q, 210, 210A-210G may be included in a predetermined robot automatic configuration 277F that defines predetermined (set-up) parameters 277FP for the respective workstation 150, 150A-150Q, 210, 210A-210G that effect interface between the articulated robot actuator 110 and the respective workstation 150, 150A-150Q, 210, 210A-210G.

Still referring to FIGS. 2A-2D, the base 201 of the collaborative robot 105 has a frame 201F, where the frame 201F defines a processing section 202 and houses (or otherwise carries) the controller 290. The process section 202 includes one or more articulated robot actuator 110 configured to at least transport labware between one or more workstations 210A-210G, 150 disposed on one or more of the collaborative robot 105, the floor 100F, and/or workbench 107 (e.g., a processing station which the collaborative robot 105 is a part of). The one or more articulated robot actuator 110 (and the collaborative robot 105 in general) is configured as a collaborative robot that conforms to, for example, International Organization for Standardization Technical Specification (ISO/TS) 15066:2016 that specifies the safety requirements for collaborative industrial robot system in a collaborative work environment, where the collaborative work environment is an environment in which the articulated robot actuator 110 operates alongside a human 106 (see FIG. 1) in a shared workspace.

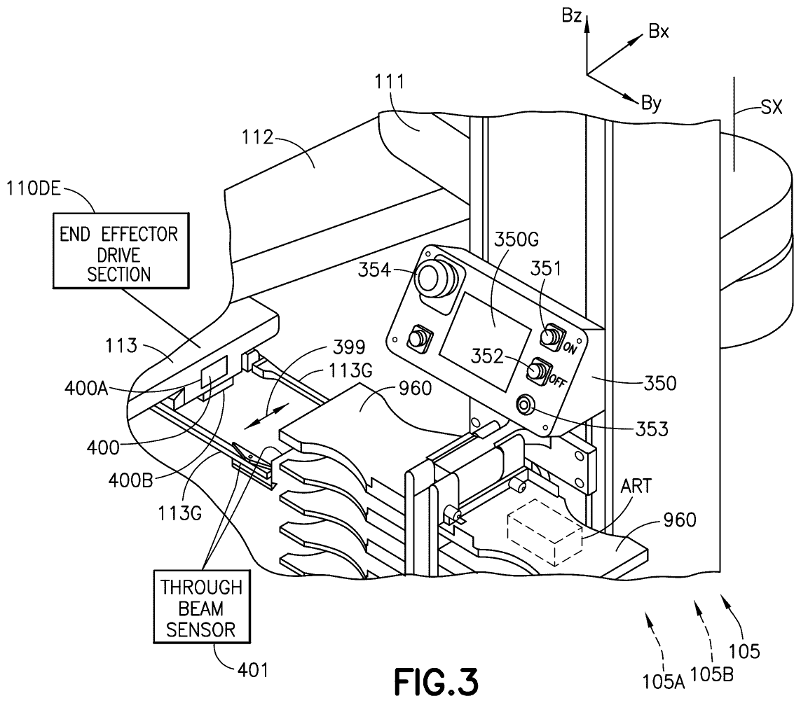

The articulated robot actuator 110 includes a frame 110F and a robot arm 110A connected to the frame 110F for movement along one or more axes Bx, By, Bz, Rx, Ry, Rz of a robot reference frame BREF. The articulated robot actuator 110 is illustrated as having a SCARA type robot arm 110A for exemplary purposes only, although the articulated robot actuator 110 may include any suitable arm (e.g., articulated arm, six-axis arm, SCARA, Cartesian, cylindrical, spherical/polar, parallel/delta, anthropomorphic, etc.) configured to at least transport any suitable labware such as plates, tubes/containers, slides, trays, etc. As illustrated in the figures, the robot arm 110A is a three-joint three-link arm having an upper arm 111 coupled to the frame 110F at a shoulder axis SX of rotation, a forearm 112 coupled to the upper arm 111 at an elbow axis EX of rotation, and the end effector 113 coupled to the forearm 112 at a wrist axis WX of rotation however, the arm 110A may include more or less than three arm links and three joints. The end effector 113 includes grippers/labware engagement members 113G that engage the labware so that the end effector 113 grips the labware for transport. The grippers 113G are illustrated in the figures, for exemplary purposes only, as being configured to grip trays or plates but it should be understood that the grippers 113G may have any suitable configuration for gripping any suitable labware. The end effector 113 may be interchangeable with other different end effectors EE1-EEn each having a different item/article handling characteristic as described herein. The grippers/labware engagement members 113G may be movable in direction 399 (see FIG. 3) towards and away from each other for gripping and releasing the labware, where the end effector 113 include any suitable end effector drive section 110DE for effecting movement of the grippers/labware engagement members 113G in direction 399.

The robot arm 110A is coupled to the frame 110F so as to traverse in the Bz direction along a mast 110M however, the robot arm 110A may not be provided with movement in the Bz direction. The articulated robot actuator 110 includes an arm drive section 110D, where the arm drive section 110D includes an arm drive 110D1, and may include a Z-axis drive 110D2. The arm drive 110D1 includes one or more motors connected to the arm links 111, 112, 113 by any suitable transmission (e.g., pulleys/belts, pulleys/bands, gears, etc.) for moving the arm links in the manner described herein. The Z-axis drive 110D2 includes any suitable motor connected to the arm 110A by any suitable transmission (e.g., pulley/belt, ball screw, etc.) for moving the arm 110A as a unit in the Bz direction. Suitable examples of robot arms that may be employed with the present disclosure are described in U.S. Pat. No. 11,123,870 issued on Sep. 21, 2021 and U.S. Pat. No. 10,955,430 issued on Mar. 23, 2021, and U.S. patent application Ser. No. 17/812,334 filed on Jul. 13, 2022 and titled “Labware Transport Robot,” the disclosures of which are incorporated herein by reference in their entireties.

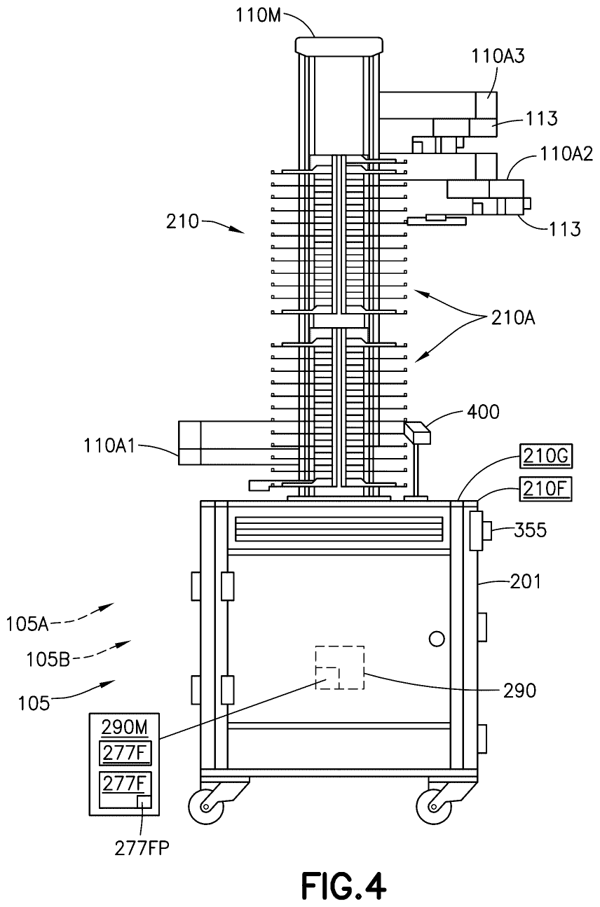

Still referring to FIGS. 2A-2D and also to FIGS. 4-6, the articulated robot actuator 110 may include one or more robot arm 110A. FIGS. 2A-2D, 5, and 6 illustrate different configurations of the collaborative robot 105 having a single robot arm 110A while FIGS. 4, 7, and 8 illustrate the collaborative robot 105 with more than one robot arm 110A1, 110A2, 110A3. The more than one robot arm 110A1, 110A2, 110A3 may be arranged along the Bz axis, disposed one above the other along the mast 110M. Each arm 110A1, 110A2, 110A3 is driven along the Bz axis by a respective Z-axis drive 110D1 where the movement of each arm 110A1, 110A2, 110A3 is coordinated, such as by controller 290, in any suitable manner with the movement of each other arm 110A1, 110A2, 110A3 along the Bz axis to effect a desired labware/sample transfer operation. Each of the arms 110A1, 110A2, 110A3 is substantially similar to arm 110A described herein however, one or more of the arms 110A1, 110A2, 110A3 may have a different configuration (e.g., articulated arm, six-axis arm, SCARA, Cartesian, cylindrical, spherical/polar, parallel/delta, anthropomorphic, etc.) than another of the more than one robot arm. It is noted that where more than one arm 110A1-110A3 is provided, each arm 110A1-110A3 may be disposed on a mast 110M that is common to each of the arms 110A1-110A3, or more than one mast 110M may be provided on the same collaborative robot 105 where each of the more than one mast 110M, 110M1 includes at least one arm 110A.

Still referring to FIGS. 2A-2D, 4, and 5-8, the processing section 202 may include a number of different workstations 210A-210G, where each of the different workstations 210A-210G has a different predetermined laboratory processing function with a different predetermined function characteristic corresponding to the workstation 210A-210G. The process section may include an end effector module 210G configured to hold one or more different selectable end effectors EE1-EEn (where n is an integer denoting an upper limit to the number of end effectors), where the robot arm 110A (see also robot arms 110A1-110A3) is configured to automatically exchange the end effector 113 with one of the end effectors EE1-EEn in a manner similar to that described in U.S. Pat. No. 10,955,430 issued Mar. 23, 2021, the disclosure of which was previously incorporated herein by reference in its entirety. Here, each of the end effectors EE1-EEn, 113 have a different process function for effecting handling of one or more item/articles ART including but not limited to a plate or tray, a microscope slide tray or rack, a sample container gripper, a slide, and manually operated tools. For example, the end effectors EE1-EEn include but are not limited to, a plate or tray gripper (e.g., for gripping any suitably sized well plate or tray such as an SBS standardized tray/plate or bespoke tray/plate or a microscope slide tray/rack), sample container gripper (e.g., for gripping any suitably sized test tube or other sample container), slide gripper (e.g., for gripping a microscope slide), anthropomorphic gripper, etc. that, when coupled to the robot arm 110A, changes a predetermined processing function characteristic of the robot arm 110A for transporting, picking, and/or placing a respective article ART (see, e.g., FIGS. 2A and 3). The plate gripper function effects articulated robot actuator 110 gripping of any suitable labware plate, the tube gripper function effects articulated robot actuator bot 110 gripping of any suitable labware tube, and the slide gripper function effects articulated robot actuator 110 gripping of any suitable labware slide. The anthropomorphic gripper function may effect articulated robot actuator 110 gripping of manually operated tools including, but not limited to, pipetting heads, brushes, Bunsen burners, microscopes, etc. that are related to a process performed at a processing station 900A-900I and/or any suitable preprocessing function (e.g., transporting manual tools to the processing station 900A-900I, cleaning the processing station 900A-900I, feeding animals within the processing station 900A-900I, etc.).

The different selectable robot arm end effectors EE1-EEn may also allow for handling articles ART such as manually operated tools for other lab interactions (in addition to sample retrieval/transport for experiments) that are generally handled by a human 106 (FIG. 1) laboratory technician, where such articles ART include any suitable sensors (e.g., imaging, temperature, humidity, potential of hydrogen (pH), thermal, optical, etc.), sprayers (e.g., for sanitizing laboratory devices with bleach, ethanol and other suitable solvents), gas delivery devices (e.g., for delivering gases such as vapor hydrogen dioxide and chlorine dioxide), pipette heads (such as single and multichannel pipette heads for acoustic fluid delivery), and ultraviolet lights (e.g., for liquid and gas free sterilization of surfaces). One or more of these articles ART may be stored on the collaborative robot 105 in/on a tool module 210F that is accessible by the robot arm 110A.

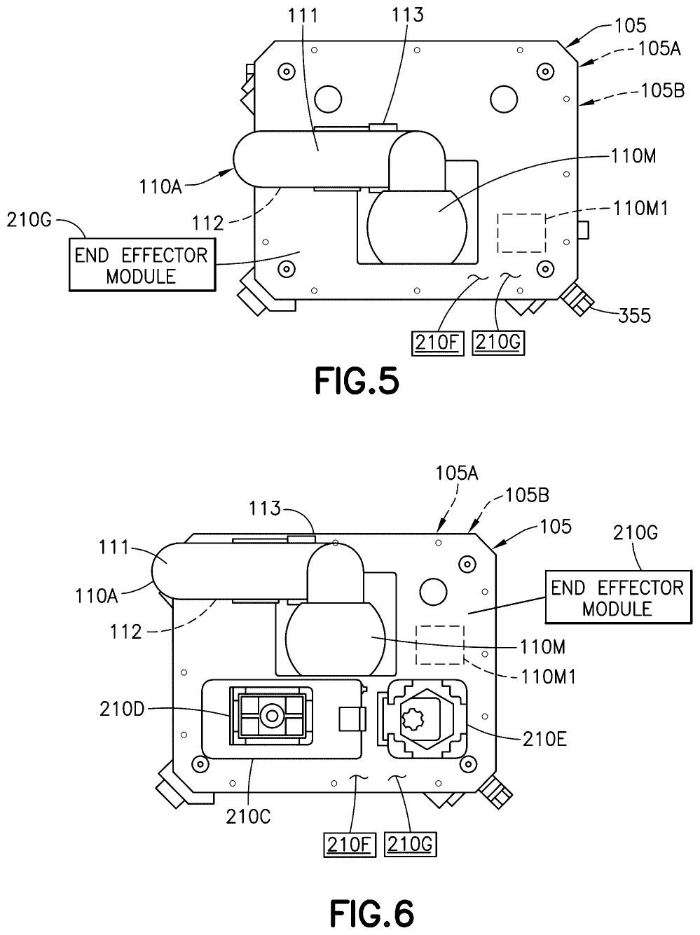

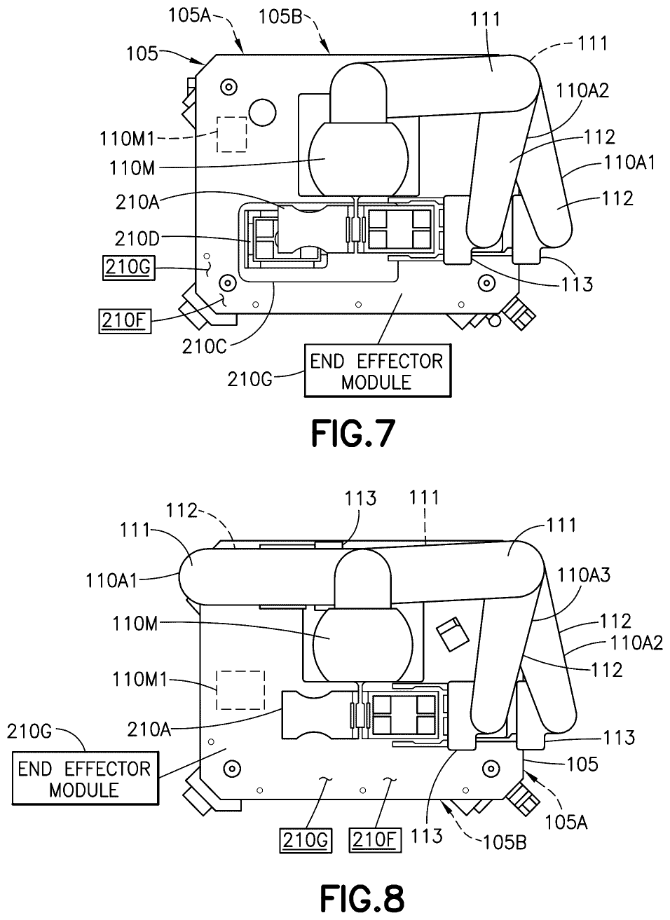

As noted herein, the processing section 202 may include one or more of: one or more workstations 210A-210G and one or more workstations 150 disposed on the collaborative robot 105 so as to be accessible to the articulated robot actuator 110. As such, the collaborative robot 105 may be configured to effect one or more of labware transport and processing onboard the collaborative robot 105. For example, FIG. 5 illustrates a collaborative robot configuration where only a single robot arm 110A is provided on the collaborative robot 105. FIG. 2B illustrates a collaborative robot configuration where a single robot arm 110A, a de-lidder 210C, plate orienter 210D, and a storage rack 210A (the storage rack being coupled to the mast 110M in any suitable manner) are provided on the collaborative robot. FIGS. 2D and 6 illustrate a collaborative robot having one robot arm 110A, a de-lidder 210C, a plate orienter 210D, and a plate hotel 210E. FIGS. 2C, 4, and 8 illustrate a collaborative robot having one or more robot arm 110A, 110A1, 110A2, 110A3 and storage rack 210A (the storage rack being coupled to the mast 110M in any suitable manner). FIG. 7 illustrates a collaborative robot having one or more robot arm 110A, 110A1, 110A2, 110A3, a de-lidder 210C, a plate orienter 210D, and storage rack 210A (the storage rack being coupled to the mast 110M in any suitable manner). It should be understood that the exemplary configurations of the collaborative robots 105 provided herein are for illustrative purposes only and that the collaborative robots 105 may have any suitable combination of and number of robot arms 110A, 110A1, 110A2, 110A3 and workstations 210A-210G, 150 for effecting a desired labware/sample process. Disposing one or more workstations 210A-210G, 150 on the collaborative robot 105 may maximize available space on the workbench 107 for human 106 operations, human-robot collaboration operations, and/or other workstations 150, and/or minimize lab/processing area 107A, 107B footprint on the floor 100F.

Referring also to FIG. 1, one example of collaboration between the robot 110 on the collaborative robot 105 and a human 106 is where the collaborative robot 105 is disposed on (either, manually moved such as with collaborative robot 105A or with moved in an automated manner such as with collaborative robot 105B) the facility floor 100F adjacent a processing station 900 which includes a human access zone 175. The articulated robot actuator 110 of the collaborative robot 105, via robot arm function, and the human 106 may effect a collaborative function at the processing station 900 where the human 106 and articulated robot actuator 110 of the collaborative robot 105 work together to complete a task, such as for example, changing a pipetting head at the processing station 900 where the robot arm 110A hands off a pipetting head from the tool module 210F to the human 106. The articulated robot actuator 110 of the collaborative robot 105, via robot arm function, and the human 106 may effect a common function at the processing station 900, such as for example, the robot arm function automatically changes the pipetting head at the processing station 900 while the human 106 operates the pipetting tool (with the pipetting head installed by the robot arm 110A) to transfer samples to/from, e.g., sample trays.

Referring to FIGS. 1 and 2B-2D, where the collaborative robot 105 is a manually traversing collaborative robot 105A (i.e., the collaborative robot 105A is not self-driving, but rather is manually pushed, manually pulled, or otherwise manually manipulated for moving the collaborative robot 105A along the floor 100F of the facility 100), the base 201 includes caster wheels 201W (two or more of which may be swivel casters) positioned for stably supporting the collaborative robot 105 on the floor 100F and effecting traverse of the collaborative robot 105 on and along the floor 100F under impetus of a human 106 (FIG. 1) pushing, pulling, or otherwise manipulating the base 201. The caster wheels 201W may include any suitable locks (i.e., a locking caster wheel) and/or the base 201 may include jack feet JF (e.g., such as at each corner of the base 201 or in any other suitable arrangement to stably support the collaborative robot 105) that when actuated (e.g., such as by a human 6 turning a jack screw JS via a jack screw handle or actuating a suitable actuator (e.g., electric or hydraulic linear actuator) with a toggle switch corresponding to a jack/leveling foot JF) lifts one or more caster wheels 201W off of the floor 100F to immobilize the base 201.

Referring to FIGS. 1 and 2A, where the collaborative robot 105 is an autonomous traverse collaborative robot 105B, the collaborative robot 105B includes a base drive section 110DC that includes one or more drive wheel motor 110D3 configured to drive, under control of controller 290) one or more drive wheels DW for effecting autonomous traverse of the collaborative robot 105 along the floor 100F. Here, the base 201 includes any suitable sensor/vision system CVS coupled to the controller 290, where the controller 290 receives data from the sensor/vision system CVS and is configured to, based on the data, effect traverse path generation and obstacle avoidance for autonomous traverse of the collaborative robot 105B along the floor 100F. The base 201, base drive section 110DC, and controller 290, for effecting autonomous traverse of the collaborative robot 105B, may be substantially similar to that described in, for example, U.S. Pat. No. 10,955,430 issued on Mar. 23, 2021 and U.S. Pat. No. 11,123,870 issued on Sep. 21, 2021, the disclosures of which were previously incorporated by reference herein in their entireties. Here, the spatial position of the collaborative robot 105B relative to the floor 100F may be maintained stationary by any suitable drive wheel or motor braking. The collaborative robot 105B may include the jack/leveling feet JF in a manner similar to collaborative robot 105A. The base 201 may also include any suitable caster wheels CW or steerable wheels that with the drive wheels DW stably support the collaborative robot 105B and effect traverse of the collaborative robot 105B along the floor 100F.

The sensor/vision system CVS of the collaborative robot 105 is provided with one or more suitable imager 400, 400A, 400B (see FIGS. 2A, 2C, 3, and 4) positioned on the collaborative robot 105 so as to read any suitable vision target 950 (see FIG. 9A, including but not limited to any suitable machine readable code/indicia such as those described herein) disposed on the labware/samples, where the vision target disposed on the labware/samples embodies an identification of the labware and/or samples held therein.

As described herein, the controller 290 is configured to identify the predetermined function characteristic (described herein) of the at least one workstation (such as at least one of workstations 150, 150A-150Q, 210A-210G) from image data (i.e., obtained from reading the vision target 950) and automatically initialize, from different predetermined robot automatic configurations (functionalities) 477F, a predetermined robot automatic configuration 477F associated with and responsive to the identified function characteristic. The initialized predetermined robot automatic configuration 277F defines predetermined (set-up) parameters 277FP (offsets, article holding type, etc., as described herein) describing the predetermined deterministic interface 997 (see, e.g., FIG. 9A) between the workstation 150, 150A-150Q, 210A-210G and the robot end effector 113. The predetermined parameters 277FP describe at least one of type, size and pose/orientation of a labware load interface or article holding station 960 of the at least one workstation 150, 150A-150Q, 210A-210G to and from which the articulated robot actuator 110 transports, pick and places an article ART (see FIG. 3—such as those described herein) with the robot end effector 113. The initialized predetermined robot automatic configuration 477F defines a robot configuration commensurate with the identified predetermined function characteristic (such as those described herein) of the at least one workstation 150, 150A-150Q, 210A-210G. The robot configuration includes for example, one or more of specific drivers and/or setup configuration parameters for interfacing with a selected device, motion characteristics (e.g., position-velocity-time (PVT) frames) of the articulated robot actuator 110, and commands (e.g., effecting processing of articles ART at a selected workstation).

The vision target 950 may include one-dimensional or two-dimensional indicia such as, but not limited to, QR-Code, DataMatrix, Cool-Data-Matrix, Aztec, ArUco Markers Trillcode, Quickmark, Shotcode, mCode, Beetagg, UPC code, Code 128, Code 39, Code 93, Codabar, PDF417, EAN-8, ITF-14, Interleaved 2 of 5, Code 11, MaxiCode, Code 49, or any other suitable one or two dimensional barcodes. As can be seen in FIGS. 2A, 2C and 4, one or more imager 400 may be fixedly mounted to the base 201 at a position accessible to (and/or on) the robot arm 110A, where the robot arm 110A moves labware (i.e., held by the end effector 113) past the imager 400 (or moves the imager 400 past the labware or workstation) for reading the machine readable code disposed on the labware/samples (or workstation); although, one or more imager 400 may be disposed on the end effector 113 (or other portion of the arm 110A) as illustrated in FIG. 3 so that the imager 400 is moved past the labware (or workstation) to read the machine readable code disposed on the labware/samples (and/or workstation) as the labware/samples are being picked or otherwise held by the end effector 113. While the imager 400 is illustrated in FIG. 3 as being disposed to read codes/indicia disposed in the Bz-Bx or Bz-By planes, as noted above, there may be more than one imager 400A, 400B disposed on the end effector 113 and arranged to face different directions. For example, imager 400A is positioned on the end effector 113 to read codes in the Bz-Bx or Bz-By planes while imager 400B is positioned on the end effector 113 to read codes in the Bx-By plane. The imager 400, 400A, 400B may be any suitable optical reader configured for imaging any suitable vision target 950. For example, the imager 400, 400A, 400B may be a laser scanner, binocular/stereo imager, time-of-flight camera or any other suitable imager configured for imaging objects and depth/range finding. It is noted that where the imager 400 is fixed to the base 201 for reading labware/samples held by the end effector 113, the depth/range finding and/or stereo vision may be omitted from the imager 400.

A through beam sensor 401 may also be provided on grippers/labware engagement members 113G of the end effector 113 where the beam of the through beam sensor 401 is positioned for scanning/detecting a presence of labware at a storage/holding location (e.g., storage rack, plate hotel, process station, etc.) accessible to the robot arm 110A.

Referring to FIG. 3, the collaborative robot 105 may include any suitable user interface 350 connected to the controller 290 for at least in part controlling the collaborative robot 105. The user interface may include graphical user interface 350G (see FIG. 3) and one or more function switches/buttons that effect or stop operation of the collaborative robot 105. For example, the one or more function switches/buttons may include on/off switches/buttons 351, 352, a lockout key switch 353, one or more emergency stop switches/buttons 354, 355 (see also FIGS. 4 and 5), and/or any other suitable switches/buttons or the like for operating the collaborative robot. The graphical user interface 350G may provide a human 106 (see FIG. 1) an operational status, process progress status, setup information, or any other suitable information regarding the operation/functionality of the collaborative robot. The graphical user interface 350G may also be configured to one or more of provide human 106 an ability to select a collaborative robot and/or processing station configuration, e.g., from a selection of pre-configured drivers/databases accessible to the controller 290 as will be described in greater detail herein, and effect setup of the collaborative robot 105 at/in a processing station by teaching pick/place or robot arm datum position for each workstation 150A-150Q (and each workstation 210A-210G) in about 1 minute or less per process module/tool as also described herein.

Referring to FIGS. 1 and 2A, as noted herein, the collaborative robot 105 is controlled by any suitable controller 290 resident onboard the collaborative robot 105. The controller 290 includes any suitable memory 290M or is configured to access any suitable memory (e.g., wirelessly or through a wired connection), on which memory 290M a listing of selectable devices 277 that may be interfaced with the collaborative robot 105 are stored. The memory 290M includes for each of the selectable processing modules/tools 150, 210A-210G a predetermined robotic automatic configuration 277F; although, the predetermined robotic automatic configuration 277F may be downloaded to the controller 290 (e.g., and stored in the memory 290M for access by the controller 290) upon a determination of the workstation pose and the identity of the predetermined function characteristic (as described herein) of the at least one workstation 150, 150A-150Q, 210A-210G.

As will be described in greater detail herein, a human 106 can co-locate the collaborative robot 105 with any suitable/desired workstations 150, 210 (i.e., so as to form a processing station), where the base 201 of the collaborative robot 105 has the undeterministic pose relative to the processing devices 150, 210 so long as the desired processing devices 150, 210 are within an operating space or known area 999 (see, e.g., FIG. 9A) of the robot arm 110A, where such placement of the collaborative robot 105 and workstations 105, 210 configures or reconfigures a work location 900. The human 106 may select, via the user interface 350, the processing devices to be interfaced with the collaborative robot 105 from the listing of selectable devices 277, teaches the collaborative robot 105 the desired destination positions of the desired processing devices 150, 210, and starts the automated processing of labware/samples substantially without specialized configurations or setup; however, the selection of devices, teaching of locations, and start of the automated processing may be effected automatically (as described herein) by the controller 290, such as with imaging of one or more vision target 950 of one or more workstation 150, 210 by the vision system CVS.

Referring to FIGS. 1, 2A, 2B, and 9A-9G, an exemplary work location (also referred to as automated work cell or processing station) 900 and its set up/configuring in the collaborative workspace (such as illustrated in FIG. 1) will be described. The collaborative robot 105 is transported (e.g., manually or automated) to a processing area 107A, 107B of, for example, any suitable workbench 107. One or more processing modules or tools 150 are non-deterministically disposed on the surface (e.g., top) of the workbench 107 and/or on the floor 100F. The collaborative robot 105 (and base 201 thereof) is non-deterministically positioned on the floor 100F relative to the one or more processing modules or tools 150 (and the one or more processing modules or tools 150 are positioned relative to the collaborative robot 105) so each labware load interface or article load station 960 of the one or more processing modules or tools 150 is located within the operating space 999 of the robot arm 110A. It is noted that the surface of the workbench 107 on which the one or more processing modules or tools 150 are seated defines a level plane LPS (such as defined/calibrated with a bubble level). The, e.g., Bx-By plane of the robot arm 110A may be adjusted with, for example, the jack/leveling feet JF of the collaborative robot 105 (e.g., manually or automatically by the controller 290 of the collaborative robot 105 by employing onboard level sensors), or in any other suitable manner, so that the Bx-By plane of robot arm 110A is substantially parallel with the level plane PLS. As may be realized, the labware load interface 960 of any process modules or tools 150 supported on the floor 100F may be leveled with respect to the workbench 107 in a similar manner to that of the robot arm 110A.

Referring to FIGS. 1 and 9A-9G, as described herein, the one or more collaborative robots 105 and one or more workstations 150 are non-deterministically positioned at a work location 900, 900A-900G, where the work location 900, 900A-900G has a polymorphic arrangement. For example, the location of the work location 900, 900A-900G on/relative to the workbench 107 may be changed, the number and types of workstations 150 at the work locations 900, 900A-900G may be changed/interchanged, the locations of the workstations 150 relative to each other (and the one or more collaborative robots 105) may change, and the number and position of the collaborative robots 105 at the work locations 900, 900A-900G may be changed so that the configuration of the work locations 900, 900A-900G is not a fixed configuration.

The tasks performed at the work locations 900, 900A-900G may vary or be changed to any desired tasks depending on the work to be performed in the collaborative process facility 100. As noted, one or more the workstations 150 of the work locations 900, 900A-900G are non-deterministically placed on the surface of a workbench 107 or disposed on the floor 100F adjacent the workbench 107 so long as the robot-workstation interface (e.g., labware load interface 960) of the one or more process look 150 is within the operating space 999 of the articulated robot actuator 110. As such, the tasks performed at each work location 900, 900A-900G may be switched depending on desired processes to be performed. As an example, work locations 900A-900G are each illustrated with respective workstations 150A-150Q however, depending on the processes to be performed any one or more of the workstations 150A-150Q may be removed from any one of the work locations 900A-900G and/or be replaced with any other of the workstations 150A-150Q so that each of the work locations 900A-900G may take on or have multiple forms (i.e., polymorphic configuration) for performing any suitable number and type of labware processes.

The one or more collaborative robots 105 may be positioned at a work location 900, 900A-900G by a human 106 or with automation so that the operating space or known area 999 of the articulated robot actuator 110 encompasses the labware load interface 960 of any process modules or tools 150 at the same work location 900A, 900A-900G. The collaborative robot 105 may be communicably coupled to each of the workstations 150 at the work location 900, 900A-900G so as to form a communication hub for the labware processes performed at the processing station 900, 900A-900G. As an example, the one or more collaborative robots may be coupled to each of the workstations 150 with a wired or wireless connection where the controller 290 (see also FIG. 2A) of the one or more collaborative robot 105 sends signals to and receives signals from the workstations 150. The signals sent between the controller 290 and the workstations 150 may embody, for example, labware placement indications, process start instructions, process completed instructions, labware identification instructions, tool setup configuration parameters/drivers and/or any other suitable information that facilitates the processing of labware or samples held therein. The one or more collaborative robots 105 may also be communicably coupled (such as through a wired or wireless connection) to a lab facility controller 199 (see FIG. 1), where the lab facility controller 199 may include management software for managing lab processes. The lab facility controller 199 includes a process scheduling software from which the controller 290 of the collaborative robot 105 may retrieve instructions for processes labware and/or samples held therein. Here, the collaborative robot 105 may initiate a process step at a workstation 150 through a signal sent from the collaborative robot 105 to the workstation 150 indicating that labware was placed at the workstation 150. Similarly, the workstation 150 may initiate an articulated robot actuator 110 pick movement where a signal sent from the workstation 150 to the collaborative robot 105 indicates labware is disposed at a labware load interface 960 of the workstation 150.

As may be realized, the processing status, location, etc. of the labware within the collaborative process facility may be tracked/recorded by any suitable controller, such as by the lab facility controller 199, in any suitable manner. For example, the imager(s) 400, 400A, 400B and the controller 290 of the collaborative robot 105 may be configured to record (via identification markings on the labware and identification of the processing tools 150) or otherwise effecting recording in any suitable memory accessible to the controllers 290, 199 the location and process performed on each labware handled by the collaborative robot 105. As may be realized, the workstation(s) 150 may also include imagers for identifying and locating labware (such as where the workstation 150 is an automated labware storage), which identification and location of the labware in the workstation 150 is communicated to the lab facility controller 199 for labware process tracking.

As noted herein, the controller 290 of the collaborative robot 105 includes any suitable memory 290M or is configured to access any suitable memory 199M (e.g., wirelessly or through a wired connection) of the lab facility controller 199. The memory 290M includes at least a device database 199DB having a listing of selectable devices 277 that may be interfaced with the collaborative robot 105. The listing of selectable devices 277 includes for each of the selectable devices (e.g., workstations/devices 150, 210A-210G), in the listing of selectable devices 277, specific drivers and/or setup configuration parameters for each of the selectable processing devices 150, 210A-210G. The memory 199M may also include a listing of the predetermined robot automatic configurations 277F that define the predetermined parameters 277FP. Data from the memory can be downloaded to the controller 290 as described herein where such data is not resident on the memory 290M onboard the collaborative robot 105.

As an example, a human 106 selects (e.g., in any suitable manner such through the user interface 350) from the list of selectable devices 277, each workstation 150A-150Q, 210A-210G interfaced with the articulated robot actuator 110 of the collaborative robot. It is noted that the devices may be selected at interface of the workstation 150A-150Q, 210A-210G with the robot such that selections for the different workstations may be made by the human 106 at different times. For example, selections for the base borne tools, such as one or more of workstations 210A-210G and/or one or more processing tools 150, may be made at configuration of the collaborative robot 105 to which the articulated robot actuator 110 is mounted, while selections for the workbench 107 borne tools (e.g., such as workstations 150A-150Q) are with the collaborative robot 105 at the processing station 900 or before transport of the cart to the processing station 900 (e.g., where made before the human 106 has knowledge of the processing tools located at the processing station 900). Selection of a workstation 210A-210G, 150, 150A-150Q automatically loads a preconfigured driver and/or setup configuration parameters into a memory of the controller 290 so as to automatically configure the articulated robot actuator 110 of the collaborative robot to physically interface with and/or communicate with the selected workstation 210A-210G, 150, 150A-150Q.

As another example, each workstation 150A-150Q, 210A-210G to be interfaced with the articulated robot actuator 110 of the collaborative robot is automatically selected by the controller 290 based on image data (i.e., pose and identity of one or more workstation 150 as described herein) obtained from imaging one or more vision target 950. Here, the controller 290 is configured to search the operating space or known area 999 of the articulated robot actuator 110 at the at least one work location 900 with the vision system CVS so as to acquire and image the vision target(s) 950 within the operating space 999. Selection of a workstation 210A-210G, 150, 150A-150Q automatically made by the controller based on the image data of the imaged vision target(s) 950 and the controller 290 loads a preconfigured driver and/or setup configuration parameters for the identified workstation(s) into the memory 290M so as to automatically configure the articulated robot actuator 110 of the collaborative robot 105 to physically interface with and/or communicate with the selected workstation 210A-210G, 150, 150A-150Q.

Referring to FIGS. 1, 2A, 3, and 9A, each of the workstations 150, 150A-150Q includes one or more vision target 950 (not shown in FIGS. 1 and 9B-9I for clarity). The vision target 950 includes a localization indicia 950L that is disposed on the workstation 150, 150A-150Q at a predetermined position relative to the labware load interface 960 of the workstation 150, 150A-150Q. Here, the predetermined position/spatial relationship between the localization indicia 950L and the labware load interface is such that pose (i.e., position and orientation) resolution/determination of the localization indicia 950L (e.g., such as by the controller 290 of the collaborative robot 105 in the articulated robot actuator 110 reference frame) automatically effects pose resolution/determination of the labware load interface 960 in the articulated robot actuator 110 reference frame. The localization indicia 950L may be any suitable indicia that provides for pose determination including, but not limited to, any suitable two-dimensional code such as those described herein. The vision target 950 may also include supporting indicia 950S, which may be any suitable barcode such as those described herein and that may embody information including, but not limited to, coordinate offsets between the localization indicia 950L and the labware load interface 960, processing tool identification (e.g., Internet Protocol (IP) address, tool type, etc.), or any other suitable information that effects one or more of automatic or manual selection of the predetermined robot automatic configurations (functionalities) 477F corresponding to the identified workstation 150 and interface between the collaborative robot 105 (and articulated robot actuator 110 thereon) and the processing tool 150, 150A-150Q and/or processing of labware (and/or specimen held therein). While localization indicia 950L and supporting indicia 950S are described, the vision target 950 may include but a single indicia embodying information for both pose determination and set-up/identification of the respective workstation.

As noted herein, the articulated robot actuator 110 includes one or more suitable imager, such as imager(s) 400, 400A, 400B (see, e.g., FIG. 3) positioned on the end effector 113 (or any other suitable location of the arm 110A or mobile base 201) for imaging the vision target 950. The controller 290 of the collaborative robot 105 includes any suitable non-transitory image processing algorithms that configure the controller 290 for pose resolution of the localization indicia 950L so that with imaging of the localization indicia 950L by the imager 400, 400A, 400B, the pose of the localization indicia 950L is known in the robot reference frame. As noted above, the imager(s) 400, 400A, 400B are configured for determining depth so that the localization of the localization indicia 950L (and the corresponding labware load interface of the respective workstation 150) is known to the controller 290 in all axes of the robot reference frame BREF. The controller 290 also includes any suitable non-transitory image processing algorithms that configure the controller 290 for acquiring the data embodied in the supporting indicia 950S such as for effecting, with the controller 290, a pose determination of the labware load interface 960 based on, for example, the coordinate offsets and the determined pose of the localization indicia 950L in the robot reference frame BREF.

As may be realized, the base borne processing tools or workstations 210A-210G and/or one or more of processing tools 150, that are mounted to the base 201, may also include the vision target 950 noted above to effect determination of each article holding location (e.g., labware load interface 960) thereof in the robot reference frame BREF.

As described above, while the positioning of the collaborative robot 105 and processing tools 150 at the processing station 900 may be non-deterministic, the interface 997 between the articulated robot actuator 110 and the process station holding locations 960 is deterministic by way of resolution of the vision target 950 in the robot reference frame.

The scanning of or detection of the vision target 950 by the controller 290 (e.g., employing the imager 400, 400A, 400B) may be effected manually or automatically. For manual detection the human 106 may move the robot arm 110A so the vision target 950 is within a field of view of the imager 400A, 400B (or move the vision target within a field of view of a stationary imager, such as imager 400). For automatic detection, the controller 290 is configured to search the operating space or known area 999 of the articulated robot actuator 110 at the at least one work location 900 with the vision system CVS so as to acquire and image the vision target(s) 950 within the operating space 999. For example, the controller 290 may command movement of the articulated robot actuator 110 so as to move the imager 400A, 400B through the operating space or known area 999 (avoiding obstacles with any suitable obstacle avoidance system) so as to detect any vision target 950 disposed within the operating space 999. With the vision target 950 detected the controller 290 determines the pose of the vision target 950, the corresponding location(s) of the labware load interface(s) 960, and the identity of the respective workstation 150.

With the vision target 950 read by the imager 400, 400A, 400B and the data embodied in the vision target 950 known to the controller 290 of the collaborative robot 105, the controller 290 automatically self-configures the collaborative robot 105 (and articulated robot actuator 110 thereof) to interface with the processing tools 210, 150 forming the processing station 900, 900A-900I. The controller 290 may employ the data obtained from reading the vision target 950 to select the identified workstations 210, 150 from the listing of selectable devices 277 so that the predetermined robot automatic configurations 277F for each of the identified workstations 210, 150 are automatically loaded into the controller 290 from the memory 290M or downloaded from any suitable remote location, such as the lab facility controller 199. As noted herein, a human 106 may select the workstations 210, 150 from the listing of selectable devices 277. Whether the processing tools are selected manually or automatically, the controller 290 via scanning of the vision target 950 automatically configures itself with the coordinate system offsets and location(s) of the labware load interface(s) 960 and any other of the predetermined parameters 277FP (as described herein) describing the predetermined deterministic interface 997 between the workstation 150, 150A-150Q, 210, 210A-210G and the robot end effector 113 for effecting labware processing.

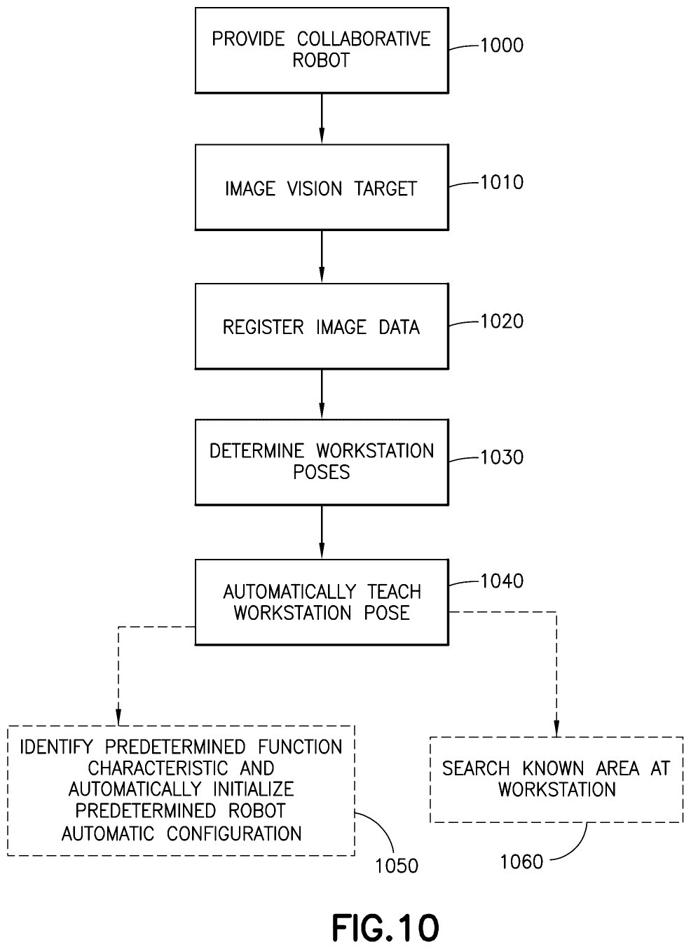

Referring to FIGS. 1, 2A-2D, 3-8, 9A-9I, and 10, an exemplary method will be described. The method includes providing the collaborative robot 105 (FIG. 10, Block 1000) as described herein. For exemplary purposes, the collaborative robot 105 includes the base 201 configured so as to movably position the collaborative robot 105 at different variable work locations 900, 900A-900I in the collaborative process facility 100 (or the collaborative robot 105 may be a bench mounted collaborative robot 105BT as described herein), at least one of which work locations 900, 900A-900I has different variable work location characteristics as described herein. The collaborative robot 105 also includes the articulated robot actuator 110, based on the base 201 and having a robot end effector 113, having a motion, driven by a drive section 110D, with at least one degree of freedom relative to the base 201 to effect with the robot end effector 113 a predetermined function corresponding to at least one workstation 150, 150A-150Q, 210, 210A-210G, from more than one different interchangeable workstation 150, 150A-150Q, 210, 210A-210G, at the at least one work location 900, 900A-900I, the at least one workstation 150, 150A-150Q, 210, 210A-210G having an undeterministic variable pose with respect to the at least one work location 900, 900A-900I. The collaborative robot 105 is also provided with the vision system CVS connected to the articulated robot actuator 110 and disposed to image a vision target 950 connected to and corresponding uniquely to each of the at least one workstation 150, 150A-150Q, 210, 210A-210G, and the controller 290 operably connected to the articulated robot actuator 110 and communicably connected to the vision system CVS as described herein. The vision system CVS images the vision target 950 (as described herein-see FIG. 10, Block 1010) connected to and corresponding uniquely to each of the at least one workstation 150, 150A-150Q, 210, 210A-210G so as to inform the workstation pose and identify a predetermined function characteristic of the at least one workstation 150, 150A-150Q, 210, 210A-210G as described herein. The controller 290 registers (e.g., records in memory 290M) the image data (FIG. 10, Block 1020) from the vision system CVS of the vision target 950. The controller 290 determines from the image data the workstation pose (FIG. 10, Block 1030) relative to the base 201. The controller 290 automatically teaches the articulated robot actuator 110 the workstation pose (as described herein-see FIG. 10, Block 1040) so as to effect a predetermined deterministic interface 997, associated with the predetermined function characteristic, between the workstation 150, 150A-150Q, 210, 210A-210G and robot end effector 113.

The method may also include one or more of identifying, with the controller 290, the predetermined function characteristic of the at least one workstation 150, 150A-150Q, 210, 210A-210G from the image data and automatically initialize, from different predetermined robot automatic configurations 277F, a predetermined robot automatic configuration associated with and responsive to the identified function characteristic (FIG. 10, Block 1050), and searching, with the controller 290, an operating space or known area 999 at the at least one work location 900, 900A-900I with the vision system CVS so as to acquire and image the vision target 950 (FIG. 10, Block 1060).

In the method one or more of, or any combination of, the following may be included: the initialized predetermined robot automatic configuration 277F defines predetermined parameters 277FP describing the predetermined deterministic interface 997 between the workstation 150, 150A-150Q, 210, 210, 210A-210G and the robot end effector 113; the predetermined parameters 277FP describe at least one of type, size and pose/orientation of an article holding station 960 of the at least one workstation 150, 150A-150Q, 210, 210A-210G to and from which the articulated robot actuator 110 transports, pick and places the article ART with the robot end effector 113; the initialized predetermined robot automatic configuration 277F defines a robot configuration commensurate with the identified predetermined function characteristic of the at least one workstation 150, 150A-150Q, 210A-210G, the robot configuration including at least one of motion characteristics (e.g., PVT frames) and commands (as described herein); the predetermined robot automatic configuration 277F is pre-stored in the memory 290M of the controller 290, or downloaded to the controller 290 upon determination of the workstation pose and the identity of the predetermined function characteristic of the at least one workstation 150, 150A-150Q, 210, 210A-210G (as described herein); the base 201 has an undeterministic pose at each of the different variable work locations 900, 900A-900I; the at least one workstation 150, 150A-150Q, 210, 210A-210G comprises one or more of a microplate dispenser, an environmental control module, a reader, a spinner, a centrifuge, a decapper, a capper, a plate hotel rack, a random access sample storage carousel, a high density labware stacker carousel, a sequential sample storage carousel, a weight scale, a de-lidder, a lidder, electronic pipettes, an electronic pipettor, and a media preparation module; the predetermined function characteristic of the at least one workstation 150, 150A-150Q, 210, 210A-210G is a function that corresponds with one or more of a microplate dispenser, an environmental control module, a reader, a spinner, a centrifuge, a decapper, a capper, a plate hotel rack, a random access sample storage carousel, a high density labware stacker carousel, a sequential sample storage carousel, a weight scale, a de-lidder, a lidder, electronic pipettes, an electronic pipettor, and a media preparation module; and the articulated robot actuator 110 is configured to handle one or more of a plate or tray, a microscope slide tray or rack, a sample container gripper, a slide, and manually operated tools.

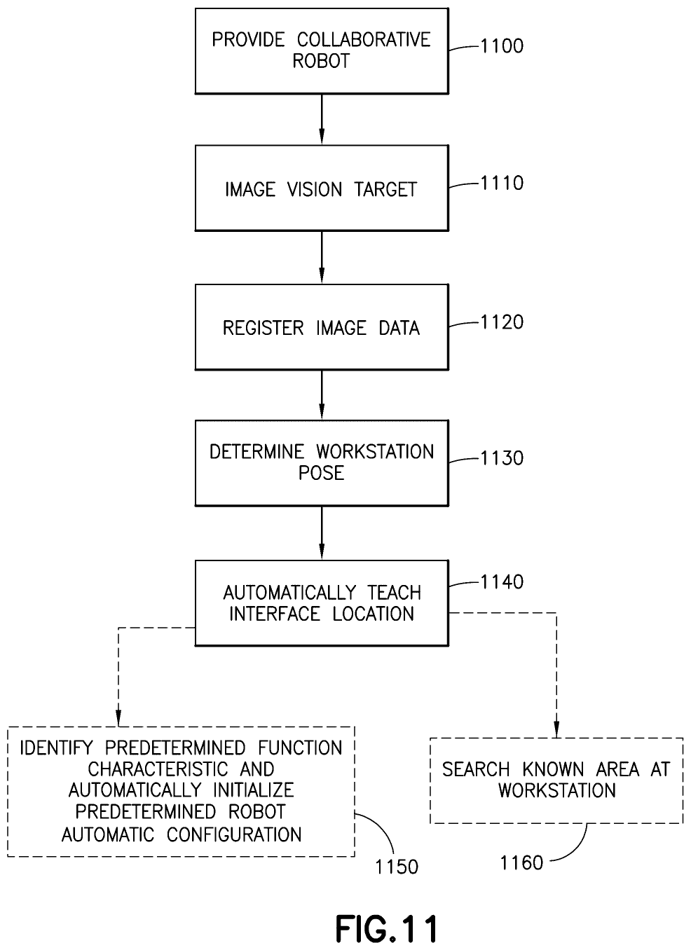

Referring to FIGS. 1, 2A-2D, 3-8, 9A-9I, and 11, an exemplary method will be described. The method includes providing the collaborative robot 105 (FIG. 11, Block 1100) as described herein. For exemplary purposes, the collaborative robot 105 includes the base 201 configured so as to movably position the collaborative robot 105 at different variable work locations 900, 900A-900I in the collaborative process facility 100 (or the collaborative robot 105 may be a bench mounted collaborative robot 105BT as described herein), at least one of which work locations 900, 900A-900I has different variable work location characteristics as described herein. The collaborative robot 105 also includes the articulated robot actuator 110, based on the base 201 and having a robot end effector 113, having a motion, driven by a drive section 110D, with at least one degree of freedom relative to the base 201 to effect with the robot end effector 113 a predetermined function corresponding to at least one workstation 150, 150A-150Q, 210, 210A-210G, from more than one different interchangeable workstation 150, 150A-150Q, 210, 210A-210G, at the at least one work location 900, 900A-900I, the at least one workstation 150, 150A-150Q, 210, 210A-210G having an undeterministic variable pose with respect to the at least one work location 900, 900A-900I. The collaborative robot 105 is also provided with the vision system CVS connected to the articulated robot actuator 110 and disposed to image a vision target 950 connected to and corresponding uniquely to each of the at least one workstation 150, 150A-150Q, 210, 210A-210G, and the controller 290 operably connected to the articulated robot actuator 110 and communicably connected to the vision system CVS as described herein. The vision system CVS images the vision target 950 (as described herein-see FIG. 11, Block 1110) connected to and corresponding uniquely to each of the at least one workstation 150, 150A-150Q, 210, 210A-210G so as to inform the workstation pose and identify a predetermined function characteristic of the at least one workstation 150, 150A-150Q, 210, 210A-210G as described herein. The controller 290 registers (e.g., records in memory 290M) the image data (FIG. 11, Block 1120) from the vision system CVS of the vision target 950. The controller 290 determines from the image data the workstation pose (FIG. 11, Block 1130) relative to the base 201. The controller 290 automatically teaches the articulated robot actuator 110 an interface location based on the workstation pose (as described herein-see FIG. 11, Block 1140) and the predetermined function characteristic identified by the image data so as to effect a predetermined deterministic interface 997 at the interface location between the at least one workstation 150, 150A-150Q, 210, 210A-210G and robot end effector 113.

The method may also include one or more of identifying, with the controller 290, the predetermined function characteristic of the at least one workstation 150, 150A-150Q, 210, 210A-210G from the image data and automatically initialize, from different predetermined robot automatic configurations 277F, a predetermined robot automatic configuration associated with and responsive to the identified function characteristic (FIG. 11, Block 1150), and searching, with the controller 290, an operating space or known area 999 at the at least one work location 900, 900A-900I with the vision system CVS so as to acquire and image the vision target 950 (FIG. 11, Block 1160).

In the method one or more of, or any combination of, the following may be included: the initialized predetermined robot automatic configuration 277F defines predetermined parameters 277FP describing the predetermined deterministic interface 997 between the workstation 150, 150A-150Q, 210, 210A-210G and the robot end effector 113; the predetermined parameters 277FP describe at least one of type, size and pose/orientation of an article holding station 960 of the at least one workstation 150, 150A-150Q, 210, 210A-210G to and from which the articulated robot actuator 110 transports, pick and places the article ART with the robot end effector 113; the initialized predetermined robot automatic configuration 277F defines a robot configuration commensurate with the identified predetermined function characteristic of the at least one workstation 150, 150A-150Q, 210, 210A-210G, the robot configuration including at least one of motion characteristics (e.g., PVT frames) and commands (as described herein); the predetermined robot automatic configuration 277F is pre-stored in the memory 290M of the controller 290, or downloaded to the controller 290 upon determination of the workstation pose and the identity of the predetermined function characteristic of the at least one workstation 150, 150A-150Q, 210, 210A-210G (as described herein); the base 201 has an undeterministic pose at each of the different variable work locations 900, 900A-900I; the at least one workstation 150, 150A-150Q, 210, 210A-210G comprises one or more of a microplate dispenser, an environmental control module, a reader, a spinner, a centrifuge, a decapper, a capper, a plate hotel rack, a random access sample storage carousel, a high density labware stacker carousel, a sequential sample storage carousel, a weight scale, a de-lidder, a lidder, electronic pipettes, an electronic pipettor, and a media preparation module; the predetermined function characteristic of the at least one workstation 150, 150A-150Q, 210, 210A-210G is a function that corresponds with one or more of a microplate dispenser, an environmental control module, a reader, a spinner, a centrifuge, a decapper, a capper, a plate hotel rack, a random access sample storage carousel, a high density labware stacker carousel, a sequential sample storage carousel, a weight scale, a de-lidder, a lidder, electronic pipettes, an electronic pipettor, and a media preparation module; and the articulated robot actuator 110 is configured to handle one or more of a plate or tray, a microscope slide tray or rack, a sample container gripper, a slide, and manually operated tools.

Referring to FIG. 9A, as noted herein, the work locations 900 described herein may be configured and reconfigured by adding, removing, and/or replacing at least one workstations 150, 210 in a set of one or more workstations 150, 210. For example, referring to FIG. 9A, an exemplary reconfiguration of the work location 900A may include the removal of workstation 150B and the replacement of workstation 150B with another workstation 150A, 150C-150Q. Another exemplary reconfiguration of the work location 900A may include the removal of workstation 150B without any replacement workstation being added. Still another exemplary reconfiguration of the work location 900A may include the adding a workstation 150A-150Q to the set of workstations disposed on the workbench 107.

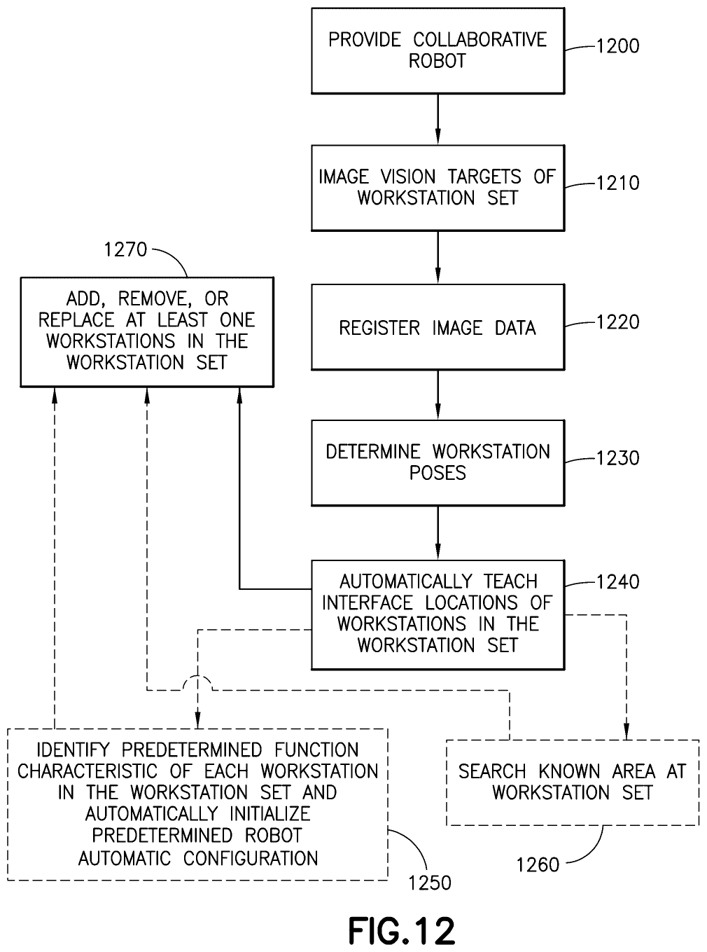

An exemplary reconfiguration method for a work location 900 will be described with respect to FIGS. 1, 2A-2D, 3-8, 9A-9I, and 12. The method includes providing the collaborative robot 105 (FIG. 12, Block 1200) as described herein. For exemplary purposes, the collaborative robot 105 includes the base 201 configured so as to movably position the collaborative robot 105 at different variable work locations 900, 900A-900I in the collaborative process facility 100 (or the collaborative robot 105 may be a bench mounted collaborative robot 105BT as described herein), at least one of which work locations 900, 900A-900I has different variable work location characteristics as described herein. The collaborative robot 105 also includes the articulated robot actuator 110, based on the base 201 and having a robot end effector 113, having a motion, driven by a drive section 110D, with at least one degree of freedom relative to the base 201 to effect with the robot end effector 113 a predetermined function corresponding to at least one workstation 150, 150A-150Q, 210, 210A-210G, from more than one different interchangeable workstation 150, 150A-150Q, 210, 210A-210G, at the at least one work location 900, 900A-900I, the at least one workstation 150, 150A-150Q, 210, 210A-210G having an undeterministic variable pose with respect to the at least one work location 900, 900A-900I. The collaborative robot 105 is also provided with the vision system CVS connected to the articulated robot actuator 110 and disposed to image a vision target 950 connected to and corresponding uniquely to each of the at least one workstation 150, 150A-150Q, 210, 210A-210G, and the controller 290 operably connected to the articulated robot actuator 110 and communicably connected to the vision system CVS as described herein. The vision system CVS images the vision targets 950 of a set of one or more workstations 150, 150A-150Q, 210, 210A-210G (as described herein-see FIG. 12, Block 1210), each vision target 950 being connected to and corresponding uniquely to a respective one of the at least one workstation 150, 150A-150Q, 210, 210A-210G so as to inform the workstation pose and identify a predetermined function characteristic of the at least one workstation 150, 150A-150Q, 210, 210A-210G as described herein. The controller 290 registers (e.g., records in memory 290M) the image data (FIG. 12, Block 1220) from the vision system CVS of the vision target 950. The controller 290 determines from the image data the workstation pose (FIG. 12, Block 1230) for each workstation 150, 150A-150Q, 210, 210A-210G of the set of workstations relative to the base 201. The controller 290 automatically teaches the articulated robot actuator 110 an interface location of each of the identified workstations 150, 150A-150Q, 210, 210A-210G based on a respective workstation pose (as described herein-see FIG. 12, Block 1240) and the predetermined function characteristic identified by the image data for the respective workstation 150, 150A-150Q, 210, 210A-210G so as to effect a predetermined deterministic interface 997 at the interface location between the respective workstation 150, 150A-150Q, 210, 210A-210G and robot end effector 113.

The method may also include one or more of identifying, with the controller 290, the predetermined function characteristic of the respective workstations 150, 150A-150Q, 210, 210A-210G from the image data and automatically initialize, from different predetermined robot automatic configurations 277F, a predetermined robot automatic configuration associated with and responsive to the identified function characteristic (FIG. 12, Block 1250), and searching, with the controller 290, an operating space or known area 999 at the set of workstations of the at least one work location 900, 900A-900I with the vision system CVS so as to acquire and image the vision target 950 (FIG. 12, Block 1260).

To reconfigure the at least one work location 900, 900A-900I, at least one workstation 150, 150A-150Q, 210, 210A-210G of the set of workstations is added, removed, or replaced (e.g., with a different workstation) (FIG. 12, Block 1270). With the reconfiguration of the at least one work location 900, 900A-900I, Blocks 1210-1240 of FIG. 12 are repeated so that the articulated robot actuator 110 is taught the new configuration of the at least one workstation 150, 150A-150Q, 210, 210A-210G. Repeating Blocks 1210-1240 of FIG. 12 after reconfiguring the workstation 150, 150A-150Q, 210, 210A-210G may be initiated manually through human 106 interaction with the user interface 350 or automatically. Where repeating Blocks 1210-1240 of FIG. 12 is initiated automatically, the controller 290 may be configured to recognize a loss of communication with one or more of the workstations, and/or to recognize establishment of communication with another workstation in any suitable manner (e.g., such as through wired or wireless connections, periodic status messages sent between the controller 290 and the workstations, searching for newly added workstations within a predetermined wireless communication range, searching for newly added workstations coupled to the controller with a wired connection, etc.). With the reconfiguration of the set of workstations taught to the articulated robot actuator 110 laboratory processing is restarted at the at least one work location 900, 900A-900I.

In the method one or more of, or any combination of, the following may be included: the initialized predetermined robot automatic configuration 277F defines predetermined parameters 277FP describing the predetermined deterministic interface 997 between the workstation 150, 150A-150Q, 210, 210A-210G in the set of workstations and the robot end effector 113; the predetermined parameters 277FP describe at least one of type, size and pose/orientation of an article holding station 960 of the at least one workstation 150, 150A-150Q, 210, 210A-210G of the set or workstations to and from which the articulated robot actuator 110 transports, pick and places the article ART with the robot end effector 113; the initialized predetermined robot automatic configuration 277F defines a robot configuration commensurate with the identified predetermined function characteristic of the at least one workstation 150, 150A-150Q, 210, 210A-210G in the set of workstations, the robot configuration including at least one of motion characteristics (e.g., PVT frames) and commands (as described herein); the predetermined robot automatic configuration 277F is pre-stored in the memory 290M of the controller 290, or downloaded to the controller 290 upon determination of the workstation pose and the identity of the predetermined function characteristic of the at least one workstation 150, 150A-150Q, 210, 210A-210G (as described herein); the base 201 has an undeterministic pose at each of the different variable work locations 900, 900A-900I; the at least one workstation 150, 150A-150Q, 210, 210A-210G of the set of workstations comprises one or more of a microplate dispenser, an environmental control module, a reader, a spinner, a centrifuge, a decapper, a capper, a plate hotel rack, a random access sample storage carousel, a high density labware stacker carousel, a sequential sample storage carousel, a weight scale, a de-lidder, a lidder, electronic pipettes, an electronic pipettor, and a media preparation module; the predetermined function characteristic of the at least one workstation 150, 150A-150Q, 210, 210A-210G is a function that corresponds with one or more of a microplate dispenser, an environmental control module, a reader, a spinner, a centrifuge, a decapper, a capper, a plate hotel rack, a random access sample storage carousel, a high density labware stacker carousel, a sequential sample storage carousel, a weight scale, a de-lidder, a lidder, electronic pipettes, an electronic pipettor, and a media preparation module; and the articulated robot actuator 110 is configured to handle one or more of a plate or tray, a microscope slide tray or rack, a sample container gripper, a slide, and manually operated tools.

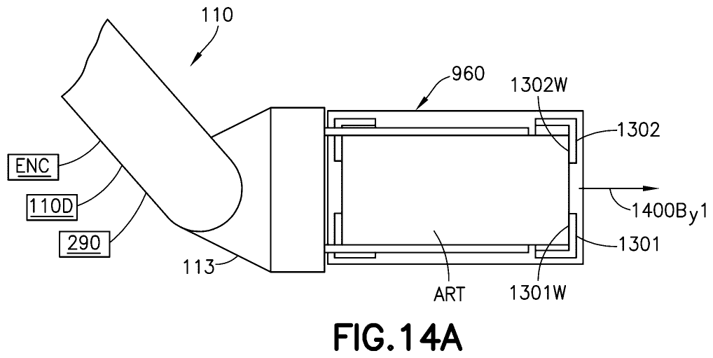

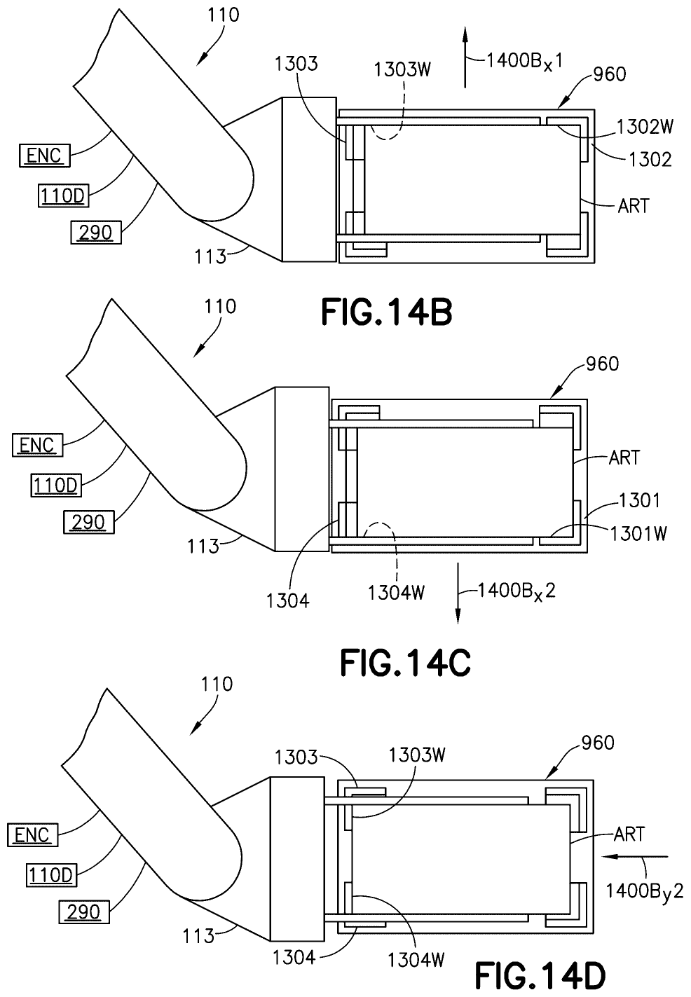

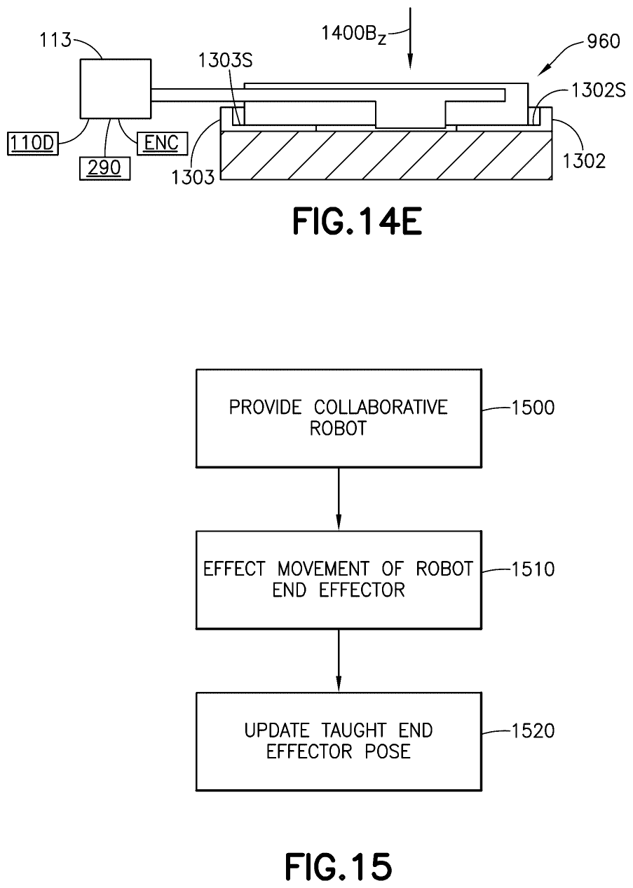

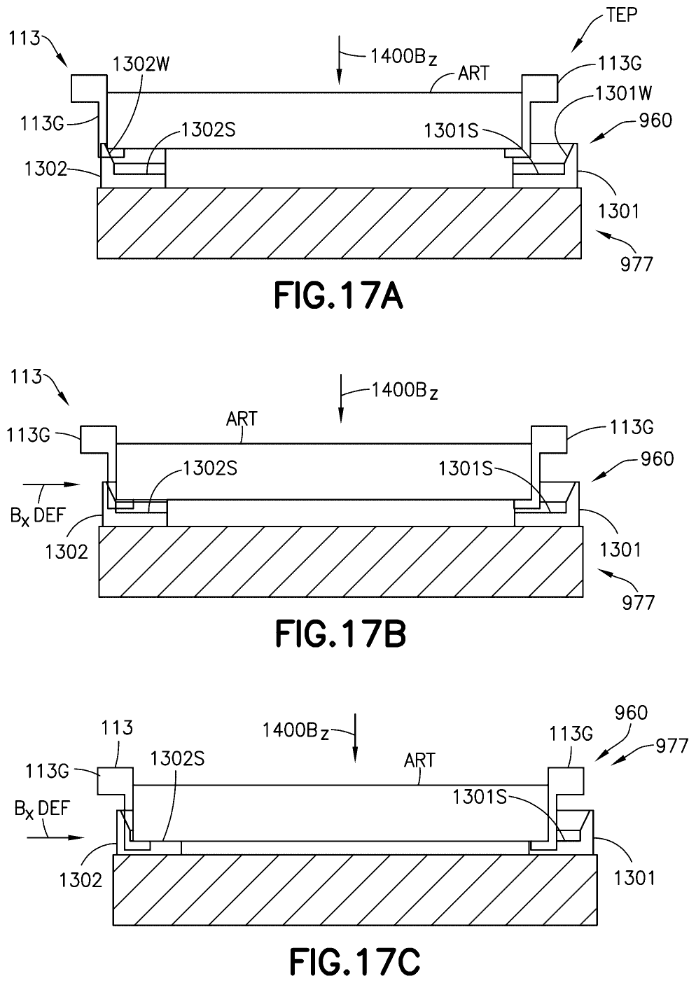

With reference to FIGS. 1, 2A, 3, 13A, and 13B (see also FIGS. 2B-2D and 4-9I), the articulated robot actuator 110 may be taught an end effector position and pose (e.g., the taught end effector pose TEP), by employing the vision system CSV and vision targets 950 as described herein, for placing an article ART at the predetermined deterministic interface 977. For example, also referring to FIGS. 17A-17C, the end effector position and pose established with the vision system CVS and vision targets 950 aligns the end effector 113 and article ART carried thereby with the predetermined deterministic interface 977 for insertion of the article ART to the receptacle 977R or area 977A. While a vertical insertion of the article ART to the predetermined deterministic interface 977 is illustrated herein (such as with respect to FIGS. 17A-17C, 18A-18C, and 14A-14E) it should be understood that a horizontal insertion may occur in the same or similar manners. With the end effector 113 in the taught end effector pose TEP, the controller 290 effects, with the drive section 11D, movement of the articulated robot actuator 110 so that the end effector 113 is moved vertically along the axis B_{Z} downwards in direction 1400B_{Z}. With the downward movement of the end effector 113 the article ART may contact one or more article supports 1301-1304 (article supports 1301, 1302 are illustrated in FIGS. 17A-17C for illustrative purposes) causing the position of the end effector 113 to deflect in one or more of the Bx and By directions (deflection of the end effector position in direction B_{X}DEF is illustrated for exemplary purposes) on insertion of the article ART to the receptacle 977R or area 977A. One of the end effector grippers 113G is illustrated as being transparent in FIGS. 17A-17C so that contact (such as a sliding contact) between the article ART and support 1302 can be seen throughout insertion and placement of the article ART at the receptacle 977R or area 977A (FIG. 17C illustrates placement or seating of the article ART on support surfaces 1301S-1304S (see FIG. 14A) of the supports 1301-1304, where only supports 1301, 1302 and support surfaces 1301S, 1302S are shown in FIG. 17C for clarity).

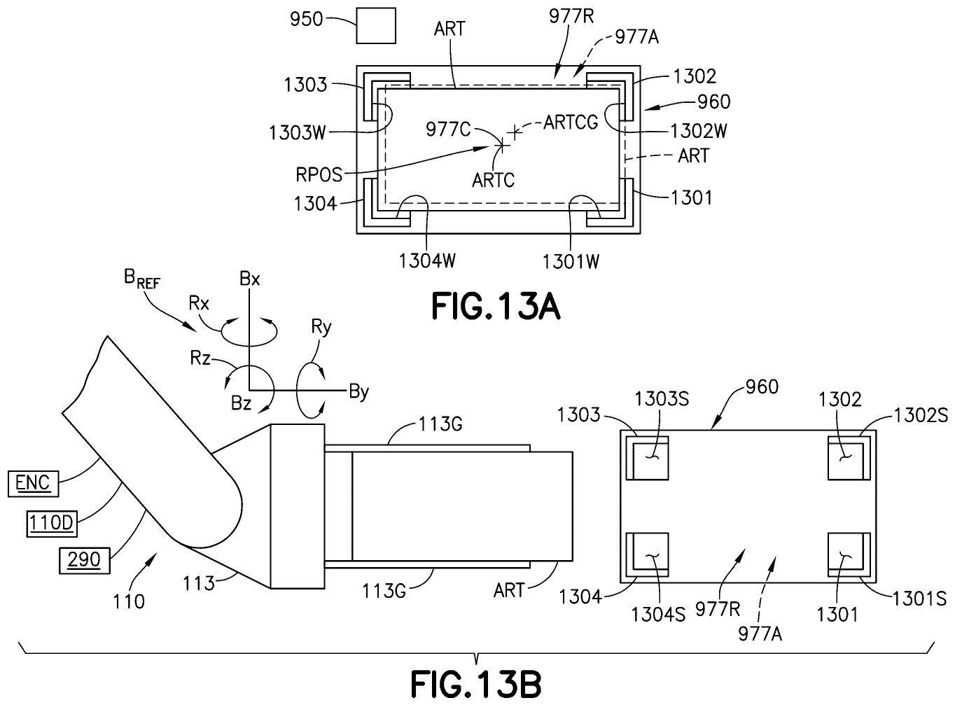

With the placement of the article ART at the predetermined deterministic interface 977 employing the taught position TEP effected by the vision system CSV and vision targets 950, a center ARTC of the article ART and a center of the predetermined deterministic interface 977C (see the article ART and corresponding center ARTCG illustrated in “dashed” lines in FIG. 13A) may not be substantially coincident with each other. The controller 290 and the articulated robot actuator 110 may be configured to refine the placement position of the article ART at the predetermined deterministic interface 977 so that the center of the article ARTC and the center of the predetermined deterministic interface 977 are substantially coincident the as illustrated in FIG. 13 or are otherwise disposed relative to each other so that the article ART is positioned at a location suitable for processing of the article ART. Refining the placement position of the article ART relative to the predetermined deterministic interface may provide for subsequent placement of an article ART at a refined position at the predetermined deterministic interface 977 substantially free of or without deflection of the articulated robot actuator 110, and/or may increase accuracy of subsequent pick/place operations of the articulated robot actuator 110.

As can be seen in FIG. 13A, the predetermined deterministic interface 977 may be sized larger than the article ART which it receives to provide suitable clearance for the insertion and removal of the article ART to and from the predetermined deterministic interface 977. To refine the placement of the article ART, substantially without articulated robot actuator 110 deflection, so that the article ART is disposed at a location/position suitable for processing of the article ART, the articulated robot actuator 110 is configured with a compliance mode in which the arm drive section 110D is back driven in the at least one degree of freedom of articulated robot actuator 110 movement. Here, the backdriveability of the articulated robot actuator 110 provides for a floating or disengagement of at least one drive motor defining the at least one degree of freedom when the movement of the articulated robot arm 110 is influenced or moved in the at least one degree of freedom by external forces (such as those applied by surfaces of the predetermined deterministic interface 977 against the end effector 113 or an article ART held by the end effector 113). The articulated robot actuator 110 includes any suitable sensors (e.g., current sensors, back EMF sensors, or any suitable force feedback sensors) to effect the backdriveability of the articulated robot actuator 110.

The articulated robot actuator 110 may include any suitable encoders ENC for tracking the position of the arm in the robot reference frame BREF so that when movement of the articulated robot actuator 110 is influenced by the outside force, the position of the articulated robot actuator 110 may be obtained by the controller 290. This compliant position determination may be employed by the controller 290 to refine the placement position of the article ART at the predetermined deterministic interface 977.

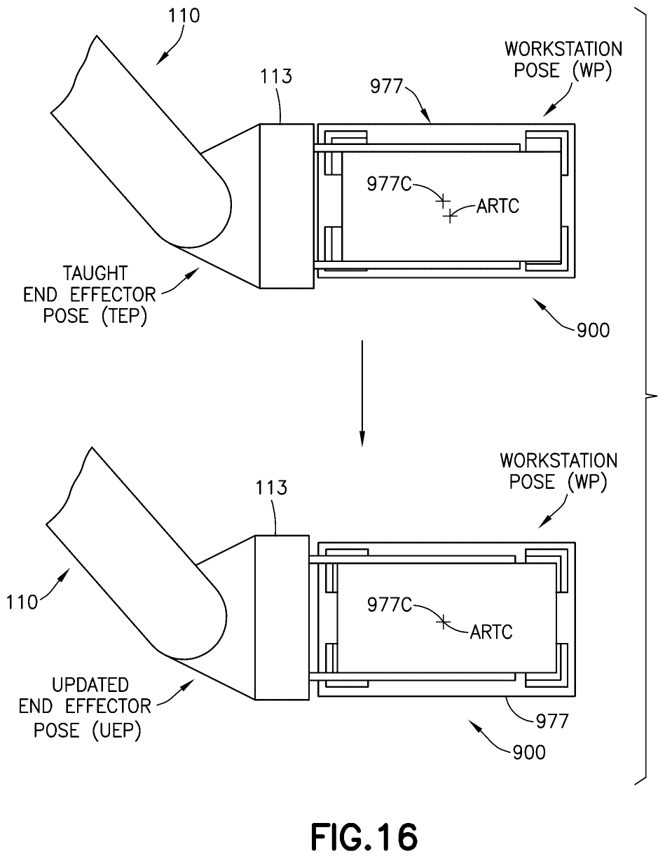

As described herein, also with reference to FIG. 16, the controller 290 is operably connected to the articulated robot actuator 110 so as to move the robot end effector 113 with the drive section 110D in the at least one degree of freedom to a taught end effector position (the taught end effector position being determined, such as with the vision targets 950 and vision system CVS described herein). With the end effector 113 at the taught end effector position, the end effector 113 may be considered to have a taught end effector pose TEP. The taught end effector position (and its pose TEP) corresponds to and substantially conforms with a pose WP of the workstation 150, 150A-150Q, 210A-210G so as so as to effect the predetermined deterministic interface 977 between the at least one workstation 150, 150A-150Q, 210A-210G and the robot end effector 113.

With the articulated robot actuator 110 in compliance mode, the robot end effector motion is biased via contact of the articulated robot actuator 110 (with the end effector 113 or article ART held by the end effector 113), at the taught end effector pose TEP, and the at least one workstation 150, 150A-150Q, 210A-210G effects compliance of the drive section 110D and changes an end effector pose in the at least one degree of freedom from the taught end effector pose TEP to an updated end effector pose UEP with reduced error (e.g., less offset from a center 977C of the predetermined deterministic interface 977 and higher conformance) with the workstation pose. The controller 290 may be configured to update the taught end effector pose TEP to the updated end effector pose UEP and the updated end effector pose UEP is (or otherwise becomes) the taught end effector pose TEP.

As illustrated in FIGS. 14A-14D (and 14E) and 18A-18C, the controller is configured to one or more of: move the robot end effector 310 so that iterative compliance via iterative contact of the articulated robot actuator 110 and at least one workstation 150, 150A-150Q, 210A-210G resolves error in the taught end effector pose TEP with the workstation pose WP; and move the robot end effector 113 so that iterative compliance via iterative contact between the articulated robot actuator 110 and the at least one workstation 150, 150A-150Q, 210A-210G resolves error in the taught end effector pose TEP with each pose of the undeterministic variable workstation pose VWP at each of the at least one variable work locations 900, 900A-900I (see also FIGS. 9A-9I).

FIGS. 13A and 13B illustrate the article holding location 960 as having article supports 1301-1304 that support the article ART, seated at the article holding location 960, and form the bounds of the receptacle 977R or area 977A. The article supports have respective seating surfaces 1301A-1304S and respective walls 1301W-1304W. To refine the taught end effector pose TEP, the controller 290 moves the end effector to the taught end effector pose TEP (see FIG. 16). With the articulated robot actuator 110 in compliance mode, the controller 290 effects, with the drive section 110D, movement of the end effector 113 so that the end effector 113 (or an article ART carried by the end effector 113) contacts one or more of the walls 1301W-1304W and/or seating surfaces 1301S-1304S so as to bias movement of the end effector 113 against the one or more walls 1301W-1304W and/or seating surfaces 1301S-1304S. While the contact is illustrated as being between an article ART carried by the end effector 113, the end effector 113 may directly contact the one or more walls 1301W-1304W and/or seating surfaces 1301S-1304S.

As described above, the initial taught pose TEP of the end effector 113, as determined with the vision system CVS may provide for placement of the article ART at the article holding location 960. Referring to FIGS. 1-9I, 13A, 13B, 16, and 18A-18E, to refine the initial taught position/pose of the end effector 113 and the placement position of the article ART at the predetermined deterministic interface 977 the controller 290 may be configured to iteratively contact the at least one workstation 150, 150A-150Q, 210A-210G where each iterative contact refines the position/pose of the end effector 113 and the placement position of the article ART at the predetermined deterministic interface 977.

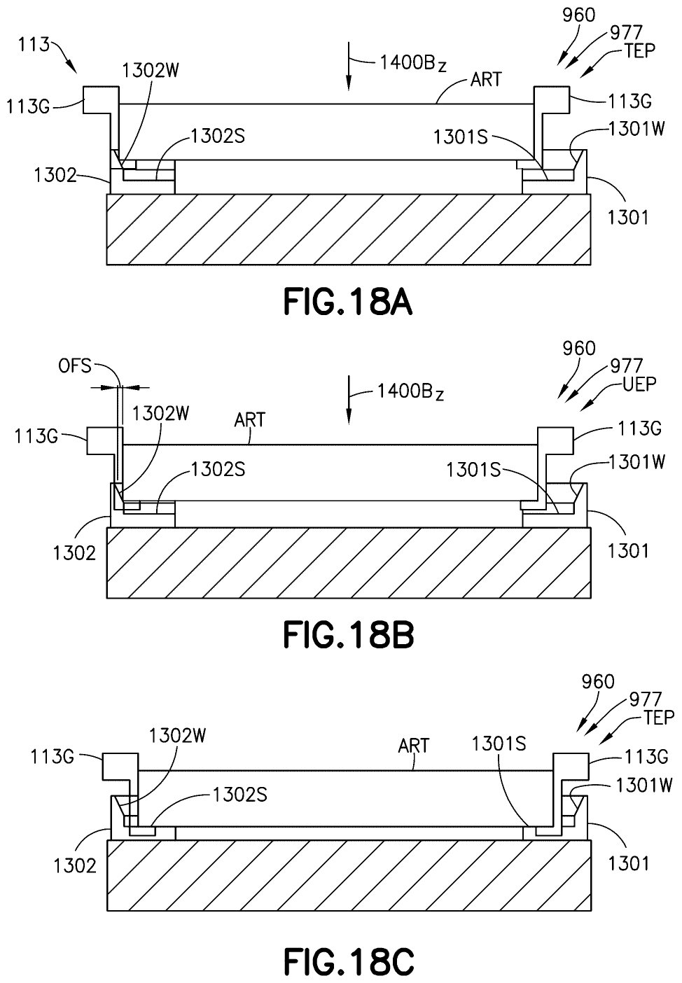

With the end effector at the taught end effector pose TEP (see FIG. 16), the controller 290 effects, with the drive section 11D, movement of the articulated robot actuator 110 so that the end effector 113 is moved vertically along the axis B_{Z} downwards in direction 1400B_{Z}. With the downward movement of the end effector 113, the end effector or article ART may contact one or more article supports 1301-1304 (article supports 1301, 1302 are illustrated in FIGS. 18A-18C for illustrative purposes) causing the position/motion of the end effector 113 to deflect in one or more of the Bx and By directions (such as described with respect to FIGS. 17A-17C) on insertion of the article ART to the receptacle 977R or area 977A. One of the end effector grippers 113G is illustrated as being transparent in FIGS. 18A-18C so that contact between the article ART and support 1302 can be seen throughout insertion and placement (FIG. 18C illustrates placement or seating of the article ART on support surfaces 1301S-1304S (see FIG. 13B) of the supports 1301-1304, only supports 1301, 1302 and support surfaces 1301S, 1302S are shown in FIG. 18C for clarity) of the article ART at the receptacle 977R or area 977A.

With deflection of the end effector 113 the controller turns off power to at least one drive motor of the drive section 110D corresponding to the deflection axis so that the articulated robot actuator 110 is back driven and compliant with the contact between the end effector 113 (or the article ART carried thereby) and the at least one workstation 150, 150A-150Q, 210A-210G. At the point/time of compliance the controller 290 registers the position/pose of the end effector 113.

The controller raises the end effector 113 away from the predetermined deterministic interface 977 and applies a predetermined offset OFS (e.g., any suitable distance that is less than the clearance provided between the article ART and the walls 1301W-1304W with the article seated at the predetermined deterministic interface 977) to update the taught end effector pose TEP to an updated end effector pose UEP, where the updated end effector pose UEP becomes the (updated) taught end effector pose TEP. The offset OFS compensates for the contact between the the end effector or article ART and the one or more article supports 1301-1304 and moves the end effector 113 (and article ART thereon) towards a center 977C of the predetermined deterministic interface 977.

With the end effector at the (updated) taught end effector pose TEP (see FIG. 18B), the controller 290 effects, with the drive section 11D, movement of the articulated robot actuator 110 so that the end effector 113 is moved vertically along the axis B_{Z} downwards in direction 1400B_{Z}. With the downward movement of the end effector 113, the end effector or article ART carried thereon may contact one or more article supports 1301-1304 causing the position/motion of the end effector 113 to deflect in one or more of the Bx and By directions such that the controller turns off power to at least one drive motor of the drive section 110D corresponding to the deflection axis so that the articulated robot actuator 110 is back driven and compliant with the contact between the end effector 113 (or the article ART carried thereby) and the at least one workstation 150, 150A-150Q, 210A-210G. At the point/time of compliance the controller 290 registers the position/pose of the end effector 113. The predetermined offset OFS is again applied to the taught end effector pose TEP to update the taught end effector pose TEP to an updated end effector pose UEP, where the updated end effector pose UEP becomes the (updated) taught end effector pose TEP. The iterative contact and offset application continues until placement of the article ART on the seating surfaces 1301S-1304S of the supports 1301-1304 is effected without compliance of the articulated robot actuator 110 relative to the walls 1301W-1304W (or other suitable bounds) of the predetermined deterministic interface 977 and the center of the article ARTC converges onto the center 977C of the article holding location (e.g., to a placement suitable for processing of the article ART), within any suitable tolerance and a placement error of the article ART relative to and at the predetermined deterministic interface 977 is substantially resolved.

Referring to FIGS. 1-9I, 13A, 13B, 14A-14E, and 16, the controller may be configured to refine the initial taught position/pose of the end effector 113 and the placement position of the article ART at the predetermined deterministic interface 977 through contact with at least two substantially orthogonal surfaces of the supports 1301-1304. It is noted that the contact described may be performed in any suitable order and one or more of the contacts described may be omitted. For example, the controller 290 effects movement of the end effector 113 in direction 1400B_{Y}1 so that the article ART contacts the walls 1301W, 1302W and the end effector motion is biased in direction 1400B_{Y}1 via the contact between the article ART and the walls 1301W, 1302W (see FIG. 14A). The controller 290 may detect the bias in any suitable manner such as with arm encoders ENC or by monitoring a current of the drive section 110D motors. The controller 290 registers (e.g., stores in any suitable memory 290M) the end effector position at the biased location in the direction 1400B_{Y}1.

The controller 290 effects movement of the end effector 113 in direction 1400B_{X}1 so that the article ART contacts the walls 1302W, 1303W and the end effector motion is biased in direction 1400B_{X}1 via the contact between the article ART and the walls 1302W, 1303W (see FIG. 14B). The controller 290 registers (e.g., stores in any suitable memory 290M) the end effector position at the biased location in the direction 1400B_{X}1.

To refine the initial taught position/pose of the end effector 113 the controller 290 may employ as few as two biased end effector positions in orthogonal directions, where the dimensions of the article holding location 960 are known. For example, the controller 290 may find a center of the article holding location 960 by employing a known width and length of the article holding locations and the determined biased positions of the substantially orthogonal bounds defined by the walls 1301W, 1302W and 1302W, 1303W; although contact between the end effector 113 (or article ART carried thereby) in more than two directions may provide increased placement accuracy/refinement.

The controller 290 effects movement of the end effector 113 in direction 1400B_{X}2 so that the article ART contacts the walls 1301W, 1304W and the end effector motion is biased in direction 1400B_{X}2 via the contact between the article ART and the walls 1301W, 1304W (see FIG. 14C). The controller 290 registers (e.g., stores in any suitable memory 290M) the end effector position at the biased location in the direction 1400B_{X}2.

The controller 290 effects movement of the end effector 113 in direction 1400B_{Y}2 so that the article ART contacts the walls 1303W, 1304W and the end effector motion is biased in direction 1400B_{Y}2 via the contact between the article ART and the walls 1303W, 1304W (see FIG. 14D). The controller 290 registers (e.g., stores in any suitable memory 290M) the end effector position at the biased location in the direction 1400B_{Y}2.

With the biased positions (as determined from encoder ENC data) in each of the directions 1400B_{X}1, 1400B_{X}2, 1400B_{Y}1, 1400B_{Y}2 the controller 290 knows the bounds of the article holding location 960 in the robot reference frame BREF and can determine, in any suitable manner, the center 977C of the article holding location 977 directly from the measured biased positions/wall locations (e.g., as determined from the encoder ENC values).

The determined center position of the article holding location 960 is employed by the controller 290 to refine the end effector pose, at the article holding location 960, to the updated end effector pose UEP, where the updated end effector pose UEP becomes the taught end effector pose TEP for subsequent end effector pose determinations/updates.

The controller 290 may also be configured to determine a height of the article holding location 960 (see FIG. 14E) where the end effector 113 is moved in direction 1400B_{Z} until the movement of the end effector 113 (via contact of the end effector 113 or article ART carried thereby with the article holding location surface 1301S-1304S) is biased against one or more surface 1301S-1304S. The controller registers the encoder ENC values at the position of the biased movement of the end effector 113, where this encoder value in the direction 1400B_{Z} sets or otherwise defines the article holding location 960 height in the robot reference frame BREF.

Referring to FIGS. 1-9I and 13A-18, an exemplary method for a collaborative robot 105 for a collaborative process facility 100 with different variable (static) work locations 900, 900A-900I in the facility 100. The method includes providing the collaborative robot 105 (FIG. 15, Block 1500) a described herein. For example, the collaborative robot 105 includes a base 201 located in the facility 100 and an articulated robot actuator 110. The articulated robot actuator is based on the base 201 and has the end effector 113 having a motion, driven by the drive section 110D, with the at least one degree of freedom relative to the base 201 to effect with the robot end effector 113 a predetermined function (such as those described herein) corresponding to at least one workstation 150, 150A-150Q, 210A-210G at one of the work locations 900, 900A-900I. The at least one workstation 150, 150A-150Q, 210A-210G having a workstation pose WP (see FIGS. 9A-9I and 16) with respect to the at least one work location 900, 900A-900I.

The controller 290 effects movement of the robot end effector 113 (FIG. 15, Block 1510) with the drive section 110D in the at least one degree of freedom to a taught end effector position, with a taught end effector pose TEP (see FIG. 16), corresponding to and substantially conformal with the workstation pose WP so as so as to effect the predetermined deterministic interface 977 between the at least one workstation 150, 150A-150Q, 210A-210G and the robot end effector 113. The articulated robot actuator 110 has the compliance mode in which the drive section 110D is back driven in the at least one degree of freedom. With the articulated robot actuator 110 in compliance mode, robot end effector motion biased via contact of the articulated robot actuator 110 at the taught end effector pose TEP and the at least one workstation 150, 150A-150Q, 210A-210G effects compliance of the drive section 110D and changes the end effector pose in the at least one degree of freedom from the taught end effector pose TEP to an updated end effector pose UEP with reduced error with the workstation pose WP (see FIG. 16 where in the updated end effector pose UEP the error is reduced so that the article center ARTC is substantially coincident with the center 977C of the article holding location, with the end effector disposed in the updated end effector pose UEP).

The controller 290 updates the taught end effector pose TEP to the updated end effector pose UEP (FIG. 15, Block 1520) and the updated end effector pose UEP is (or otherwise becomes) the taught end effector pose TEP.

The method may include one or more of the following, individually, in any suitable combination thereof, and/or in any suitable combination with the features described herein:

the controller 290, moving the robot end effector 113 so that iterative compliance via iterative contact of the articulated robot actuator 110 and at least one workstation 150, 150A-150Q, 210A-210G resolves error in the taught end effector pose TEP with the workstation pose WP (see FIG. 16); the base 201 is a movable base configured so as to movably position the articulated robot actuator 110 at the different variable work locations 900, 900A-900I in the facility 100, at least one of which work locations 900, 900A-900I has different variable work location characteristics; the workstation pose WP is an undeterministic variable pose VWP of the at least one work station 150, 150A-150Q, 210A-210G at the at least one of the variable work locations 900, 900A-900I; the controller 290, moving the robot end effector 113 so that iterative compliance via iterative contact between the articulated robot actuator 110 and the at least one workstation 150, 150A-150Q, 210A-210G resolves error in the taught end effector pose TEP with each pose of the undeterministic variable workstation pose VWP at each of the at least one variable work locations 900, 900A-900I; providing a vision system CVS connected to the articulated robot actuator 110 and disposed to image a vision target 950 connected to and corresponding uniquely to each of the at least one workstation 150, 150A-150Q, 210A-210G so as to inform the workstation pose WP and identify a predetermined function characteristic of the at least one workstation 150, 150A-150Q, 210A-210G, and registering, with the controller 290 operably connected to the articulated robot actuator 110 and communicably connected to the vision system CVS, image data from the vision system CVS of the vision target 950, and determining, with the controller 290, from the image data the workstation pose WP relative to the base 201 and automatically teaching the articulated robot actuator 110 the workstation pose WP so as to effect a predetermined deterministic interface 977, associated with the predetermined function characteristic, between the at least one workstation 150, 150A-150Q, 210A-210G and robot end effector 113; with the controller 290, identifying the predetermined function characteristic of the at least one workstation 150, 150A-150Q, 210A-210G from the image data and automatically initialize, from different predetermined robot automatic configurations, a predetermined robot automatic configuration associated with and responsive to the identified function characteristic; the initialized predetermined robot automatic configuration defines predetermined parameters describing the predetermined deterministic interface 977 between the workstation 150, 150A-150Q, 210A-210G and the robot end effector 113; the predetermined parameters describe at least one of type, size and pose/orientation of an article holding station of the at least one workstation to and from which the articulated robot actuator 110 transports, pick and places the article ART with the robot end effector 113; the initialized predetermined robot automatic configuration defines a robot configuration commensurate with the identified predetermined function characteristic of the at least one workstation 150, 150A-150Q, 210A-210G, the robot configuration including at least one of motion characteristics and commands; the predetermined robot automatic configuration is pre-stored in a memory 290M of the controller 290, or downloaded to the controller 290 upon determination of the workstation pose WP and the identity of the predetermined function characteristic of the at least one workstation 150, 150A-150Q, 210A-210G; the base 201 is movable and has an undeterministic pose at each of the different variable work locations 900, 900A-900I; with the controller 290, searching a known area 999 at the at least one work location 900, 900A-900I with the vision system CVS so as to acquire and image the vision target 950; the at least one workstation 150, 150A-150Q, 210A-210G comprises one or more of a microplate dispenser, an environmental control module, a reader, a spinner, a centrifuge, a decapper, a capper, a plate hotel rack, a random access sample storage carousel, a high density labware stacker carousel, a sequential sample storage carousel, a weight scale, a de-lidder, a lidder, electronic pipettes, an electronic pipettor, and a media preparation module; the predetermined function characteristic of the at least one workstation 150, 150A-150Q, 210A-210G is a function that corresponds with one or more of a microplate dispenser, an environmental control module, a reader, a spinner, a centrifuge, a decapper, a capper, a plate hotel rack, a random access sample storage carousel, a high density labware stacker carousel, a sequential sample storage carousel, a weight scale, a de-lidder, a lidder, electronic pipettes, an electronic pipettor, and a media preparation module; and the articulated robot actuator 110 is configured to handle one or more of a plate or tray, a microscope slide tray or rack, a sample container gripper, a slide, and manually operated tools.

The following are provided in accordance with the present disclosure and may be employed individually, in any combination with each other, and/or in any combination with the features described above:

A collaborative robot for a collaborative process facility is provided. The robot comprising: a movable base configured so as to movably position the collaborative robot at different variable work locations in the collaborative process facility, at least one of which work locations has different variable work location characteristics; an articulated robot actuator, based on the movable base and having a robot end effector, having a motion, driven by a drive section, with at least one degree of freedom relative to the movable base to effect with the robot end effector a predetermined function corresponding to at least one workstation, from more than one different interchangeable workstation, at the at least one work location, the at least one workstation having an undeterministic variable pose with respect to the at least one work location; a vision system connected to the articulated robot actuator and disposed to image a vision target connected to and corresponding uniquely to each of the at least one workstation so as to inform the workstation pose and identify a predetermined function characteristic of the at least one workstation; and a controller operably connected to the articulated robot actuator and communicably connected to the vision system to register image data from the vision system of the vision target, the controller being configured so as to determine from the image data the workstation pose relative to the movable base and automatically teach the articulated robot actuator the workstation pose so as to effect a predetermined deterministic interface, associated with the predetermined function characteristic, between the workstation and robot end effector.

The collaborative robot includes one or more of the following, individually or in any suitable combination thereof or in any suitable combination with the features described herein:
the controller is configured to identify the predetermined function characteristic of the at least one workstation from the image data and automatically initialize, from different predetermined robot automatic configurations, a predetermined robot automatic configuration associated with and responsive to the identified function characteristic;
the initialized predetermined robot automatic configuration defines predetermined parameters describing the predetermined deterministic interface between the workstation and the robot end effector;
the predetermined parameters describe at least one of type, size and pose/orientation of an article holding station of the at least one workstation to and from which the articulated robot actuator transports, pick and places the article with the robot end effector;
the initialized predetermined robot automatic configuration defines a robot configuration commensurate with the identified predetermined function characteristic of the at least one workstation, the robot configuration including at least one of motion characteristics and commands;
the predetermined robot automatic configuration is pre-stored in a memory of the controller, or downloaded to the controller upon determination of the workstation pose and the identity of the predetermined function characteristic of the at least one workstation;
the movable base has an undeterministic pose at each of the different variable work locations;
controller is configured to search a known area at the at least one work location with the vision system so as to acquire and image the vision target;
the at least one workstation comprises one or more of a microplate dispenser, an environmental control module, a reader, a spinner, a centrifuge, a decapper, a capper, a plate hotel rack, a random access sample storage carousel, a high density labware stacker carousel, a sequential sample storage carousel, a weight scale, a de-lidder, a lidder, electronic pipettes, an electronic pipettor, and a media preparation module;
the predetermined function characteristic of the at least one workstation is a function that corresponds with one or more of a microplate dispenser, an environmental control module, a reader, a spinner, a centrifuge, a decapper, a capper, a plate hotel rack, a random access sample storage carousel, a high density labware stacker carousel, a sequential sample storage carousel, a weight scale, a de-lidder, a lidder, electronic pipettes, an electronic pipettor, and a media preparation module; and
the articulated robot actuator is configured to handle one or more of a plate or tray, a microscope slide tray or rack, a sample container gripper, a slide, and manually operated tools.

A collaborative robot for a collaborative process facility is provided. The robot comprising: a movable base configured so as to movably position the collaborative robot at different variable work locations in the collaborative process facility, at least one of which work locations has different variable work location characteristics; an articulated robot actuator, based on the movable base and having a robot end effector, having a motion, driven by a drive section, with at least one degree of freedom relative to the movable base to effect with the robot end effector a predetermined function corresponding to at least one workstation, from more than one different interchangeable workstation, at the at least one work location, the at least one workstation having an undeterministic variable pose with respect to the at least one work location; a vision system connected to the articulated robot actuator and disposed to image a vision target connected to and corresponding uniquely to each of the at least one workstation so as to inform the workstation pose and identify a predetermined function characteristic of the at least one workstation; and a controller operably connected to the articulated robot actuator and communicably connected to the vision system register image data from the vision system of the vision target, the controller being configured so as to determine from the image data the workstation pose relative to the movable base and automatically teach the articulated robot actuator an interface location based on the workstation pose and the predetermined function characteristic identified by the image data so as to effect a predetermined deterministic interface at the interface location between the at least one workstation and robot end effector.

The collaborative robot includes one or more of the following, individually or in any suitable combination thereof or in any suitable combination with the features described herein:
the controller is configured to identify the predetermined function characteristic of the at least one workstation from the image data and automatically initialize, from different predetermined robot automatic configurations, a predetermined robot automatic configuration associated with and responsive to the identified function characteristic;
the initialized predetermined robot automatic configuration defines predetermined parameters describing the predetermined deterministic interface between the workstation and the robot end effector;
the predetermined parameters describe at least one of type, size and pose/orientation of an article holding station of the at least one workstation to and from which the articulated robot actuator transports, pick and places the article with the robot end effector;
the initialized predetermined robot automatic configuration defines a robot configuration commensurate with the identified predetermined function characteristic of the at least one workstation, the robot configuration including at least one of motion characteristics and commands;
the predetermined robot automatic configuration is pre-stored in a memory of the controller, or downloaded to the controller upon determination of the workstation pose and the identity of the predetermined function characteristic of the at least one workstation;
the movable base has an undeterministic pose at each of the different variable work locations;
the controller is configured to search a known area at the at least one work location with the vision system so as to acquire and image the vision target;
the at least one workstation comprises one or more of a microplate dispenser, an environmental control module, a reader, a spinner, a centrifuge, a decapper, a capper, a plate hotel rack, a random access sample storage carousel, a high density labware stacker carousel, a sequential sample storage carousel, a weight scale, a de-lidder, a lidder, electronic pipettes, an electronic pipettor, and a media preparation module;
the predetermined function characteristic of the at least one workstation is a function that corresponds with one or more of a microplate dispenser, an environmental control module, a reader, a spinner, a centrifuge, a decapper, a capper, a plate hotel rack, a random access sample storage carousel, a high density labware stacker carousel, a sequential sample storage carousel, a weight scale, a de-lidder, a lidder, electronic pipettes, an electronic pipettor, and a media preparation module; and
the articulated robot actuator is configured to handle one or more of a plate or tray, a microscope slide tray or rack, a sample container gripper, a slide, and manually operated tools.

A method for a collaborative robot in a collaborative process facility is provided. The method comprising: providing the collaborative robot, the collaborative robot comprising: a movable base configured so as to movably position the collaborative robot at different variable work locations in the collaborative process facility, at least one of which work locations has different variable work location characteristics, an articulated robot actuator, based on the movable base and having a robot end effector, having a motion, driven by a drive section, with at least one degree of freedom relative to the movable base to effect with the robot end effector a predetermined function corresponding to at least one workstation, from more than one different interchangeable workstation, at the at least one work location, the at least one workstation having an undeterministic variable pose with respect to the at least one work location, a vision system connected to the articulated robot actuator and disposed to image a vision target connected to and corresponding uniquely to each of the at least one workstation, and a controller operably connected to the articulated robot actuator and communicably connected to the vision system; imaging, with the vision system, the vision target connected to and corresponding uniquely to each of the at least one workstation so as to inform the workstation pose and identify a predetermined function characteristic of the at least one workstation; and with the controller: registering image data from the vision system of the vision target, determining from the image data the workstation pose relative to the movable base, and automatically teaching the articulated robot actuator the workstation pose so as to effect a predetermined deterministic interface, associated with the predetermined function characteristic, between the workstation and robot end effector.

The method includes one or more of the following, individually or in any suitable combination thereof or in any suitable combination with the features described herein:
with the controller, identifying the predetermined function characteristic of the at least one workstation from the image data and automatically initializing, from different predetermined robot automatic configurations, a predetermined robot automatic configuration associated with and responsive to the identified function characteristic;
the initialized predetermined robot automatic configuration defines predetermined parameters describing the predetermined deterministic interface between the workstation and the robot end effector;
the predetermined parameters describe at least one of type, size and pose/orientation of an article holding station of the at least one workstation to and from which the articulated robot actuator transports, pick and places the article with the robot end effector;
the initialized predetermined robot automatic configuration defines a robot configuration commensurate with the identified predetermined function characteristic of the at least one workstation, the robot configuration including at least one of motion characteristics and commands;
the predetermined robot automatic configuration is pre-stored in a memory of the controller, or downloaded to the controller upon determination of the workstation pose and the identity of the predetermined function characteristic of the at least one workstation;
the movable base has an undeterministic pose at each of the different variable work locations;
with the controller, searching a known area at the at least one work location with the vision system so as to acquire and image the vision target;
the at least one workstation comprises one or more of a microplate dispenser, an environmental control module, a reader, a spinner, a centrifuge, a decapper, a capper, a plate hotel rack, a random access sample storage carousel, a high density labware stacker carousel, a sequential sample storage carousel, a weight scale, a de-lidder, a lidder, electronic pipettes, an electronic pipettor, and a media preparation module;
the predetermined function characteristic of the at least one workstation is a function that corresponds with one or more of a microplate dispenser, an environmental control module, a reader, a spinner, a centrifuge, a decapper, a capper, a plate hotel rack, a random access sample storage carousel, a high density labware stacker carousel, a sequential sample storage carousel, a weight scale, a de-lidder, a lidder, electronic pipettes, an electronic pipettor, and a media preparation module; and
the articulated robot actuator is configured to handle one or more of a plate or tray, a microscope slide tray or rack, a sample container gripper, a slide, and manually operated tools.

A method for a collaborative robot in a collaborative process facility is provided. The method comprising: providing the collaborative robot, the collaborative robot comprising: a movable base configured so as to movably position the collaborative robot at different variable work locations in the collaborative process facility, at least one of which work locations has different variable work location characteristics, an articulated robot actuator, based on the movable base and having a robot end effector, having a motion, driven by a drive section, with at least one degree of freedom relative to the movable base to effect with the robot end effector a predetermined function corresponding to at least one workstation, from more than one different interchangeable workstation, at the at least one work location, the at least one workstation having an undeterministic variable pose with respect to the at least one work location, a vision system connected to the articulated robot actuator and disposed to image a vision target connected to and corresponding uniquely to each of the at least one workstation, and a controller operably connected to the articulated robot actuator and communicably connected to the vision system; imaging, with the vision system, the vision target connected to and corresponding uniquely to each of the at least one workstation so as to inform the workstation pose and identify a predetermined function characteristic of the at least one workstation; and with the controller: registering image data from the vision system of the vision target, determining from the image data the workstation pose relative to the movable base, and automatically teaching the articulated robot actuator an interface location based on the workstation pose and the predetermined function characteristic identified by the image data so as to effect a predetermined deterministic interface at the interface location between the at least one workstation and robot end effector.

The method includes one or more of the following, individually or in any suitable combination thereof or in any suitable combination with the features described herein:
with the controller, identifying the predetermined function characteristic of the at least one workstation from the image data and automatically initializing, from different predetermined robot automatic configurations, a predetermined robot automatic configuration associated with and responsive to the identified function characteristic;
the initialized predetermined robot automatic configuration defines predetermined parameters describing the predetermined deterministic interface between the workstation and the robot end effector;
the predetermined parameters describe at least one of type, size and pose/orientation of an article holding station of the at least one workstation to and from which the articulated robot actuator transports, pick and places the article with the robot end effector;
the initialized predetermined robot automatic configuration defines a robot configuration commensurate with the identified predetermined function characteristic of the at least one workstation, the robot configuration including at least one of motion characteristics and commands;
the predetermined robot automatic configuration is pre-stored in a memory of the controller, or downloaded to the controller upon determination of the workstation pose and the identity of the predetermined function characteristic of the at least one workstation;
the movable base has an undeterministic pose at each of the different variable work locations;
with the controller, searching a known area at the at least one work location with the vision system so as to acquire and image the vision target;
the at least one workstation comprises one or more of a microplate dispenser, an environmental control module, a reader, a spinner, a centrifuge, a decapper, a capper, a plate hotel rack, a random access sample storage carousel, a high density labware stacker carousel, a sequential sample storage carousel, a weight scale, a de-lidder, a lidder, electronic pipettes, an electronic pipettor, and a media preparation module;
the predetermined function characteristic of the at least one workstation is a function that corresponds with one or more of a microplate dispenser, an environmental control module, a reader, a spinner, a centrifuge, a decapper, a capper, a plate hotel rack, a random access sample storage carousel, a high density labware stacker carousel, a sequential sample storage carousel, a weight scale, a de-lidder, a lidder, electronic pipettes, an electronic pipettor, and a media preparation module; and
the articulated robot actuator is configured to handle one or more of a plate or tray, a microscope slide tray or rack, a sample container gripper, a slide, and manually operated tools.

A collaborative robot, for a collaborative process facility with different variable work locations in the facility, is provided. The robot comprising: a base located in the facility; an articulated robot actuator based on the base and having a robot end effector having a motion, driven by a drive section, with at least one degree of freedom relative to the base to effect with the robot end effector a predetermined function corresponding to at least one workstation at one of the work locations, the at least one workstation having a workstation pose with respect to the at least one work location; and a controller operably connected to the articulated robot actuator so as to move the robot end effector with the drive section in the at least one degree of freedom to a taught end effector position, with a taught end effector pose, corresponding to and substantially conformal with the workstation pose so as so as to effect a predetermined deterministic interface between the at least one workstation and the robot end effector; wherein the articulated robot actuator has a compliance mode in which the drive section is back driven in the at least one degree of freedom, and with the articulated robot actuator in compliance mode, robot end effector motion biased via contact of the articulated robot actuator, at the taught end effector pose, and the at least one workstation effects compliance of the drive section and changes an end effector pose in the at least one degree of freedom from the taught end effector pose to an updated end effector pose with reduced error with the workstation pose; and wherein the controller is configured to update the taught end effector pose to the updated end effector pose and the updated end effector pose is the taught end effector pose.

The collaborative robot includes one or more of the following, individually or in any suitable combination thereof or in any suitable combination with the features described herein:
the controller is configured to move the robot end effector so that iterative compliance via iterative contact of the articulated robot actuator and at least one workstation resolves error in the taught end effector pose with the workstation pose;
the base is a movable base configured so as to movably position the articulated robot actuator at the different variable work locations in the facility, at least one of which work locations has different variable work location characteristics;
the workstation pose is an undeterministic variable pose of the at least one work station at the at least one of the variable work locations;
the controller is configured to move the robot end effector so that iterative compliance via iterative contact between the articulated robot actuator and the at least one workstation resolves error in the taught end effector pose with each pose of the undeterministic variable workstation pose at each of the at least one variable work locations;
the collaborative robot of claim 1, further comprises: a vision system connected to the articulated robot actuator and disposed to image a vision target connected to and corresponding uniquely to each of the at least one workstation so as to inform the workstation pose and identify a predetermined function characteristic of the at least one workstation; and wherein the controller is operably connected to the articulated robot actuator and communicably connected to the vision system to register image data from the vision system of the vision target, the controller being configured so as to determine from the image data the workstation pose relative to the base and automatically teach the articulated robot actuator the workstation pose so as to effect a predetermined deterministic interface, associated with the predetermined function characteristic, between the at least one workstation and robot end effector;
the controller is configured to identify the predetermined function characteristic of the at least one workstation from the image data and automatically initialize, from different predetermined robot automatic configurations, a predetermined robot automatic configuration associated with and responsive to the identified function characteristic;
the initialized predetermined robot automatic configuration defines predetermined parameters describing the predetermined deterministic interface between the workstation and the robot end effector;
the predetermined parameters describe at least one of type, size and pose/orientation of an article holding station of the at least one workstation to and from which the articulated robot actuator transports, pick and places the article with the robot end effector;
the initialized predetermined robot automatic configuration defines a robot configuration commensurate with the identified predetermined function characteristic of the at least one workstation, the robot configuration including at least one of motion characteristics and commands;
the predetermined robot automatic configuration is pre-stored in a memory of the controller, or downloaded to the controller upon determination of the workstation pose and the identity of the predetermined function characteristic of the at least one workstation;
the base is movable and has an undeterministic pose at each of the different variable work locations;
the controller is configured to search a known area at the at least one work location with the vision system so as to acquire and image the vision target;
the at least one workstation comprises one or more of a microplate dispenser, an environmental control module, a reader, a spinner, a centrifuge, a decapper, a capper, a plate hotel rack, a random access sample storage carousel, a high density labware stacker carousel, a sequential sample storage carousel, a weight scale, a de-lidder, a lidder, electronic pipettes, an electronic pipettor, and a media preparation module;
the predetermined function characteristic of the at least one workstation is a function that corresponds with one or more of a microplate dispenser, an environmental control module, a reader, a spinner, a centrifuge, a decapper, a capper, a plate hotel rack, a random access sample storage carousel, a high density labware stacker carousel, a sequential sample storage carousel, a weight scale, a de-lidder, a lidder, electronic pipettes, an electronic pipettor, and a media preparation module; and
the articulated robot actuator is configured to handle one or more of a plate or tray, a microscope slide tray or rack, a sample container gripper, a slide, and manually operated tools.

A method for a collaborative robot for a collaborative process facility with different variable work locations in the facility is provided. The method comprising: providing the collaborative robot where the collaborative robot includes: a base located in the facility, and an articulated robot actuator based on the base and having a robot end effector having a motion, driven by a drive section, with at least one degree of freedom relative to the base to effect with the robot end effector a predetermined function corresponding to at least one workstation at one of the work locations, the at least one workstation having a workstation pose with respect to the at least one work location; and with a controller operably connected to the articulated robot actuator: effecting movement of the robot end effector with the drive section in the at least one degree of freedom to a taught end effector position, with a taught end effector pose, corresponding to and substantially conformal with the workstation pose so as so as to effect a predetermined deterministic interface between the at least one workstation and the robot end effector, wherein the articulated robot actuator has a compliance mode in which the drive section is back driven in the at least one degree of freedom, and with the articulated robot actuator in compliance mode, robot end effector motion biased via contact of the articulated robot actuator at the taught end effector pose, and the at least one workstation effects compliance of the drive section and changes an end effector pose in the at least one degree of freedom from the taught end effector pose to an updated end effector pose with reduced error with the workstation pose; and updating, with the controller, the taught end effector pose to the updated end effector pose and the updated end effector pose is the taught end effector pose.

The method includes one or more of the following, individually or in any suitable combination thereof or in any suitable combination with the features described herein:
with the controller, moving the robot end effector so that iterative compliance via iterative contact of the articulated robot actuator and at least one workstation resolves error in the taught end effector pose with the workstation pose;
the base is a movable base configured so as to movably position the articulated robot actuator at the different variable work locations in the facility, at least one of which work locations has different variable work location characteristics;
the workstation pose is an undeterministic variable pose of the at least one work station at the at least one of the variable work locations;
with the controller, moving the robot end effector so that iterative compliance via iterative contact between the articulated robot actuator and the at least one workstation resolves error in the taught end effector pose with each pose of the undeterministic variable workstation pose at each of the at least one variable work locations;
the method further comprising: providing a vision system connected to the articulated robot actuator and disposed to image a vision target connected to and corresponding uniquely to each of the at least one workstation so as to inform the workstation pose and identify a predetermined function characteristic of the at least one workstation; and registering, with the controller operably connected to the articulated robot actuator and communicably connected to the vision system, image data from the vision system of the vision target; and determining, with the controller, from the image data the workstation pose relative to the base and automatically teaching the articulated robot actuator the workstation pose so as to effect a predetermined deterministic interface, associated with the predetermined function characteristic, between the at least one workstation and robot end effector;
with the controller, identifying the predetermined function characteristic of the at least one workstation from the image data and automatically initialize, from different predetermined robot automatic configurations, a predetermined robot automatic configuration associated with and responsive to the identified function characteristic;
the initialized predetermined robot automatic configuration defines predetermined parameters describing the predetermined deterministic interface between the workstation and the robot end effector;
the predetermined parameters describe at least one of type, size and pose/orientation of an article holding station of the at least one workstation to and from which the articulated robot actuator transports, pick and places the article with the robot end effector;
the initialized predetermined robot automatic configuration defines a robot configuration commensurate with the identified predetermined function characteristic of the at least one workstation, the robot configuration including at least one of motion characteristics and commands;
the predetermined robot automatic configuration is pre-stored in a memory of the controller, or downloaded to the controller upon determination of the workstation pose and the identity of the predetermined function characteristic of the at least one workstation;
the base is movable and has an undeterministic pose at each of the different variable work locations;
with the controller, searching a known area at the at least one work location with the vision system so as to acquire and image the vision target;
the at least one workstation comprises one or more of a microplate dispenser, an environmental control module, a reader, a spinner, a centrifuge, a decapper, a capper, a plate hotel rack, a random access sample storage carousel, a high density labware stacker carousel, a sequential sample storage carousel, a weight scale, a de-lidder, a lidder, electronic pipettes, an electronic pipettor, and a media preparation module;
the predetermined function characteristic of the at least one workstation is a function that corresponds with one or more of a microplate dispenser, an environmental control module, a reader, a spinner, a centrifuge, a decapper, a capper, a plate hotel rack, a random access sample storage carousel, a high density labware stacker carousel, a sequential sample storage carousel, a weight scale, a de-lidder, a lidder, electronic pipettes, an electronic pipettor, and a media preparation module; and
the articulated robot actuator is configured to handle one or more of a plate or tray, a microscope slide tray or rack, a sample container gripper, a slide, and manually operated tools.

It should be understood that the foregoing description is only illustrative of the present disclosure. Various alternatives and modifications can be devised by those skilled in the art without departing from the present disclosure. Accordingly, the present disclosure is intended to embrace all such alternatives, modifications and variances that fall within the scope of any claims appended hereto. Further, the mere fact that different features are recited in mutually different dependent or independent claims does not indicate that a combination of these features cannot be advantageously used, such a combination remaining within the scope of the present disclosure.

What is claimed is:

1. A collaborative robot for a collaborative process facility, the robot comprising:
a movable base configured so as to movably position the collaborative robot at different variable work locations in the collaborative process facility, at least one of which work locations has different variable work location characteristics;
an articulated robot actuator, based on the movable base and having a robot end effector, having a motion, driven by a drive section, with at least one degree of freedom relative to the movable base to effect with the robot end effector a predetermined function corresponding to at least one workstation, from more than one different interchangeable workstation, at the at least one work location, the at least one workstation having an undeterministic variable pose with respect to the at least one work location;
a vision system connected to the articulated robot actuator and disposed to image a vision target connected to and corresponding uniquely to each of the at least one workstation so as to inform the workstation pose and identify a predetermined function characteristic of the at least one workstation; and
a controller operably connected to the articulated robot actuator and communicably connected to the vision system to register image data from the vision system of the vision target, the controller being configured so as to determine from the image data the workstation pose relative to the movable base and automatically teach the articulated robot actuator the workstation pose so as to effect a predetermined deterministic interface, associated with the predetermined function characteristic, between the workstation and robot end effector.

2. The collaborative robot of claim 1, wherein the controller is configured to identify the predetermined function characteristic of the at least one workstation from the image data and automatically initialize, from different predetermined robot automatic configurations, a predetermined robot automatic configuration associated with and responsive to the identified function characteristic.

3. The collaborative robot of claim 2, wherein the initialized predetermined robot automatic configuration defines predetermined parameters describing the predetermined deterministic interface between the workstation and the robot end effector.

4. The collaborative robot of claim 3, wherein the predetermined parameters describe at least one of type, size and pose/orientation of an article holding station of the at least one workstation to and from which the articulated robot actuator transports, pick and places the article with the robot end effector.

5. The collaborative robot of claim 2, wherein the initialized predetermined robot automatic configuration defines a robot configuration commensurate with the identified predetermined function characteristic of the at least one workstation, the robot configuration including at least one of motion characteristics and commands.

6. The collaborative robot of claim 2, wherein the predetermined robot automatic configuration is pre-stored in a memory of the controller, or downloaded to the controller upon determination of the workstation pose and the identity of the predetermined function characteristic of the at least one workstation.

7. The collaborative robot of claim 1, wherein the movable base has an undeterministic pose at each of the different variable work locations.

8. The collaborative robot of claim 1, wherein the controller is configured to search a known area at the at least one work location with the vision system so as to acquire and image the vision target.

9. The collaborative robot of claim 1, wherein the at least one workstation comprises one or more of a microplate dispenser, an environmental control module, a reader, a spinner, a centrifuge, a decapper, a capper, a plate hotel rack, a random access sample storage carousel, a high density labware stacker carousel, a sequential sample storage carousel, a weight scale, a de-lidder, a lidder, electronic pipettes, an electronic pipettor, and a media preparation module.

10. The collaborative robot of claim 1, wherein the predetermined function characteristic of the at least one workstation is a function that corresponds with one or more of a microplate dispenser, an environmental control module, a reader, a spinner, a centrifuge, a decapper, a capper, a plate hotel rack, a random access sample storage carousel, a high density labware stacker carousel, a sequential sample storage carousel, a weight scale, a de-lidder, a lidder, electronic pipettes, an electronic pipettor, and a media preparation module.

11. The collaborative robot of claim 1, wherein the articulated robot actuator is configured to handle one or more of a plate or tray, a microscope slide tray or rack, a sample container gripper, a slide, and manually operated tools.

12. A collaborative robot for a collaborative process facility, the robot comprising:
a movable base configured so as to movably position the collaborative robot at different variable work locations in the collaborative process facility, at least one of which work locations has different variable work location characteristics;
an articulated robot actuator, based on the movable base and having a robot end effector, having a motion, driven by a drive section, with at least one degree of freedom relative to the movable base to effect with the robot end effector a predetermined function corresponding to at least one workstation, from more than one different interchangeable workstation, at the at least one work location, the at least one workstation having an undeterministic variable pose with respect to the at least one work location;
a vision system connected to the articulated robot actuator and disposed to image a vision target connected to and corresponding uniquely to each of the at least one workstation so as to inform the workstation pose and identify a predetermined function characteristic of the at least one workstation; and
a controller operably connected to the articulated robot actuator and communicably connected to the vision system register image data from the vision system of the vision target, the controller being configured so as to determine from the image data the workstation pose relative to the movable base and automatically teach the articulated robot actuator an interface location based on the workstation pose and the predetermined function characteristic identified by the image data so as to effect a predetermined deterministic interface at the interface location between the at least one workstation and robot end effector.

13. The collaborative robot of claim 12, wherein the controller is configured to identify the predetermined function characteristic of the at least one workstation from the image data and automatically initialize, from different predetermined robot automatic configurations, a predetermined robot automatic configuration associated with and responsive to the identified function characteristic.

14. The collaborative robot of claim 12, wherein the at least one workstation comprises one or more of a microplate dispenser, an environmental control module, a reader, a spinner, a centrifuge, a decapper, a capper, a plate hotel rack, a random access sample storage carousel, a high density labware stacker carousel, a sequential sample storage carousel, a weight scale, a de-lidder, a lidder, electronic pipettes, an electronic pipettor, and a media preparation module.

15. The collaborative robot of claim 12, wherein the predetermined function characteristic of the at least one workstation is a function that corresponds with one or more of a microplate dispenser, an environmental control module, a reader, a spinner, a centrifuge, a decapper, a capper, a plate hotel rack, a random access sample storage carousel, a high density labware stacker carousel, a sequential sample storage carousel, a weight scale, a de-lidder, a lidder, electronic pipettes, an electronic pipettor, and a media preparation module.

16. The collaborative robot of claim 12, wherein the articulated robot actuator is configured to handle one or more of a plate or tray, a microscope slide tray or rack, a sample container gripper, a slide, and manually operated tools.

17. A method for a collaborative robot in a collaborative process facility, the method comprising:
providing the collaborative robot, the collaborative robot comprising:
a movable base configured so as to movably position the collaborative robot at different variable work locations in the collaborative process facility, at least one of which work locations has different variable work location characteristics,
an articulated robot actuator, based on the movable base and having a robot end effector, having a motion, driven by a drive section, with at least one degree of freedom relative to the movable base to effect with the robot end effector a predetermined function corresponding to at least one workstation, from more than one different interchangeable workstation, at the at least one work location, the at least one workstation having an undeterministic variable pose with respect to the at least one work location,
a vision system connected to the articulated robot actuator and disposed to image a vision target connected to and corresponding uniquely to each of the at least one workstation, and
a controller operably connected to the articulated robot actuator and communicably connected to the vision system;
imaging, with the vision system, the vision target connected to and corresponding uniquely to each of the at least one workstation so as to inform the workstation pose and identify a predetermined function characteristic of the at least one workstation; and
with the controller:
registering image data from the vision system of the vision target,
determining from the image data the workstation pose relative to the movable base, and
automatically teaching the articulated robot actuator the workstation pose so as to effect a predetermined deterministic interface, associated with the predetermined function characteristic, between the workstation and robot end effector.

18. The method of claim 17, further comprising, with the controller, identifying the predetermined function characteristic of the at least one workstation from the image data and automatically initializing, from different predetermined robot automatic configurations, a predetermined robot automatic configuration associated with and responsive to the identified function characteristic.

19. A collaborative robot for a collaborative process facility with different variable work locations in the facility, the robot comprising:
a base located in the facility;
an articulated robot actuator based on the base and having a robot end effector having a motion, driven by a drive section, with at least one degree of freedom relative to the base to effect with the robot end effector a predetermined function corresponding to at least one workstation at one of the work locations, the at least one workstation having a workstation pose with respect to the at least one work location; and
a controller operably connected to the articulated robot actuator so as to move the robot end effector with the drive section in the at least one degree of freedom to a taught end effector position, with a taught end effector pose, corresponding to and substantially conformal with the workstation pose so as so as to effect a predetermined deterministic interface between the at least one workstation and the robot end effector;
wherein the articulated robot actuator has a compliance mode in which the drive section is back driven in the at least one degree of freedom, and with the articulated robot actuator in compliance mode, robot end effector motion biased via contact of the articulated robot actuator, at the taught end effector pose, and the at least one workstation effects compliance of the drive section and changes an end effector pose in the at least one degree of freedom from the taught end effector pose to an updated end effector pose with reduced error with the workstation pose; and
wherein the controller is configured to update the taught end effector pose to the updated end effector pose and the updated end effector pose is the taught end effector pose.

20. The collaborative robot of claim 19, wherein the controller is configured to move the robot end effector so that iterative compliance via iterative contact of the articulated robot actuator and at least one workstation resolves error in the taught end effector pose with the workstation pose.

21. The collaborative robot of claim 19, wherein the base is a movable base configured so as to movably position the articulated robot actuator at the different variable work locations in the facility, at least one of which work locations has different variable work location characteristics.

22. The collaborative robot of claim 21, wherein the workstation pose is an undeterministic variable pose of the at least one work station at the at least one of the variable work locations.

23. The collaborative robot of claim 21, wherein the controller is configured to move the robot end effector so that iterative compliance via iterative contact between the articulated robot actuator and the at least one workstation resolves error in the taught end effector pose with each pose of the undeterministic variable workstation pose at each of the at least one variable work locations.

24. The collaborative robot of claim 19, further comprising:
a vision system connected to the articulated robot actuator and disposed to image a vision target connected to and corresponding uniquely to each of the at least one workstation so as to inform the workstation pose and identify a predetermined function characteristic of the at least one workstation; and
wherein the controller is operably connected to the articulated robot actuator and communicably connected to the vision system to register image data from the vision system of the vision target, the controller being configured so as to determine from the image data the workstation pose relative to the base and automatically teach the articulated robot actuator the workstation pose so as to effect a predetermined deterministic interface, associated with the predetermined function characteristic, between the at least one workstation and robot end effector.

25. The collaborative robot of claim 24, wherein the controller is configured to identify the predetermined function characteristic of the at least one workstation from the image data and automatically initialize, from different predetermined robot automatic configurations, a predetermined robot automatic configuration associated with and responsive to the identified function characteristic.

26. The collaborative robot of claim 25, wherein the initialized predetermined robot automatic configuration defines predetermined parameters describing the predetermined deterministic interface between the workstation and the robot end effector.

27. The collaborative robot of claim 26, wherein the predetermined parameters describe at least one of type, size and pose/orientation of an article holding station of the at least one workstation to and from which the articulated robot actuator transports, pick and places the article with the robot end effector.

28. The collaborative robot of claim 25, wherein the initialized predetermined robot automatic configuration defines a robot configuration commensurate with the identified predetermined function characteristic of the at least one workstation, the robot configuration including at least one of motion characteristics and commands.

29. The collaborative robot of claim 25, wherein the predetermined robot automatic configuration is pre-stored in a memory of the controller, or downloaded to the controller upon determination of the workstation pose and the identity of the predetermined function characteristic of the at least one workstation.

30. The collaborative robot of claim 24, wherein the base is movable and has an undeterministic pose at each of the different variable work locations.

31. The collaborative robot of claim 24, wherein the controller is configured to search a known area at the at least one work location with the vision system so as to acquire and image the vision target.

32. The collaborative robot of claim 24, wherein the at least one workstation comprises one or more of a microplate dispenser, an environmental control module, a reader, a spinner, a centrifuge, a decapper, a capper, a plate hotel rack, a random access sample storage carousel, a high density labware stacker carousel, a sequential sample storage carousel, a weight scale, a de-lidder, a lidder, electronic pipettes, an electronic pipettor, and a media preparation module.

33. The collaborative robot of claim 24, wherein the predetermined function characteristic of the at least one workstation is a function that corresponds with one or more of a microplate dispenser, an environmental control module, a reader, a spinner, a centrifuge, a decapper, a capper, a plate hotel rack, a random access sample storage carousel, a high density labware stacker carousel, a sequential sample storage carousel, a weight scale, a de-lidder, a lidder, electronic pipettes, an electronic pipettor, and a media preparation module.

34. The collaborative robot of claim 24, wherein the articulated robot actuator is configured to handle one or more of a plate or tray, a microscope slide tray or rack, a sample container gripper, a slide, and manually operated tools.

35. A method for a collaborative robot for a collaborative process facility with different variable work locations in the facility, the method comprising:
providing the collaborative robot where the collaborative robot includes:
a base located in the facility, and
an articulated robot actuator based on the base and having a robot end effector having a motion, driven by a drive section, with at least one degree of freedom relative to the base to effect with the robot end effector a predetermined function corresponding to at least one workstation at one of the work locations, the at least one workstation having a workstation pose with respect to the at least one work location; and
with a controller operably connected to the articulated robot actuator:
effecting movement of the robot end effector with the drive section in the at least one degree of freedom to a taught end effector position, with a taught end effector pose, corresponding to and substantially conformal with the workstation pose so as so as to effect a predetermined deterministic interface between the at least one workstation and the robot end effector,
wherein the articulated robot actuator has a compliance mode in which the drive section is back driven in the at least one degree of freedom, and with the articulated robot actuator in compliance mode, robot end effector motion biased via contact of the articulated robot actuator at the taught end effector pose, and the at least one workstation effects compliance of the drive section and changes an end effector pose in the at least one degree of freedom from the taught end effector pose to an updated end effector pose with reduced error with the workstation pose; and
updating, with the controller, the taught end effector pose to the updated end effector pose and the updated end effector pose is the taught end effector pose.
